(19) United States
(12) Patent Application Publication
(10) Pub. No.: US 2020/0368690 A1
(43) Pub. Date: Nov. 26, 2020

(54) POLYMERIC IONOMER SEPARATION MEMBRANES AND METHODS OF USE

(71) Applicant: 3M INNOVATIVE PROPERTIES COMPANY, St. Paul, MN (US)

(72) Inventors: Michael A. Yandrasits, Hastings, MN (US); David Scott Seitz, Woodbury, MN (US); Eric F. Funkenbusch, Hudson, WI (US); Ryan C. Shirk, Mendota Heights, MN (US); Jinsheng Zhou, Woodbury, MN (US); Eric J. Hanson, Hudson, WI (US); Moses M. David, Wells, TX (US); Kazuhiko Mizuno, Tokyo (JP)

(21) Appl. No.: 16/638,171

(22) PCT Filed: Aug. 14, 2018
(86) PCT No.: PCT/IB2018/056106

§ 371 Date: Feb. 11, 2020

Related U.S. Application Data
(60) Provisional application No. 62/546,154, filed on Aug. 16, 2017.

(51) Int. Cl. B01D 61/36; B01D 71/32; B01D 69/12; B01D 71/46; B01D 67/00; B01D 69/02

(52) U.S. Cl. CPC B01D 61/362; B01D 71/32; B01D 69/12; B01D 71/46; B01D 67/0093; B01D 2325/022; B01D 69/02; B01D 2313/44; B01D 2323/30; B01D 2323/345; B01D 67/0088

(57) ABSTRACT

A separation membrane for selectively separating (e.g., pervaporating) a first fluid (e.g., a first liquid) from a mixture comprising the first fluid (e.g., first liquid) and a second fluid (e.g., second liquid), wherein the separation membrane includes a polymeric ionomer that has a highly fluorinated backbone and recurring pendant groups according to the following formula (Formula I): —O—R_{f}—[—SO₂—N⁻(Z⁺)—SO₂—R—]ₘ—[SO₂]ₙ-Q wherein: R_{f} is a perfluorinated organic linking group; R is an organic linking group; Z⁺ is H⁺, a monovalent cation, or a multivalent cation; Q is H, F, —NH, —O-2 Y+, or —CₓF₂ₓ₊₁; Y⁺ is H⁺, a monovalent cation, or a multivalent cation; x=1 to 4; m=0 to 6; and n=0 or 1; with the proviso that at least one of m or n must be non-zero.

### BACKGROUND

Separation membranes are known; however, there is a continual need for effective composite membranes.

### SUMMARY OF THE INVENTION

The present disclosure provides separation membranes (e.g., composite membranes) and methods of use of such membranes in separation techniques. Generally, the separation membranes include a polymeric ionomer, wherein the polymeric ionomer has a highly fluorinated backbone and recurring pendant groups according to the following formula:

—O—R_{f}—[—SO₂—N⁻(Z⁺)—SO₂—R—]ₘ—[SO₂]ₙ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4;
   m=0 to 6; and
   n=0 or 1;
   with the proviso that at least one of m or n must be non-zero.

In certain embodiments, the separation membranes may be composite membranes that include a porous substrate (i.e., a support substrate that may include one or more layers) that includes opposite first and second major surfaces, and a plurality of pores; and a polymeric ionomer that forms a layer having a thickness in and/or on the porous substrate.

In certain embodiments the layer is a continuous layer. In certain embodiments the composite membrane is an asymmetric composite membrane. For composite membranes that are asymmetric, the amount of the polymeric ionomer at, or adjacent to, the first major surface is greater than the amount of the polymeric ionomer at, or adjacent to, the second major surface.

Such membranes are particularly useful for selectively pervaporating a first liquid from a mixture that includes the first liquid and a second liquid (e.g., alcohols, particularly higher octane alcohols, aromatics, and other high octane compounds), generally because the polymeric ionomer is more permeable to the first liquid than the second liquid (e.g., gasoline and other such fuels).

The second liquid (e.g., gasoline) could naturally include the first liquid (e.g., high octane compounds), or the first liquid (e.g., alcohols or high octane compounds) could be added to the second liquid (e.g., gasoline).

Separation membranes of the present disclosure may be included in a cartridge, which may be part of a system such as a flex-fuel engine.

The present disclosure also provides methods. For example, the present disclosure provides a method of separating by pervaporating a first liquid (e.g., ethanol, other higher octane alcohols, aromatics, and other high octane compounds) from a mixture of the first liquid (e.g., ethanol, other higher octane alcohols, aromatics, and other high octane compounds) and a second liquid (e.g., gasoline and other such fuels), the method comprising contacting the mixture with a separation membrane (e.g., a composite membrane, and preferably, an asymmetric composite membrane) as described herein.

Herein, “gasoline” refers to refined petroleum used as fuel for internal combustion engines.

Herein, a “high octane” compound is one that has an octane level (i.e., octane rating or octane number), which is a standard measure of the performance of gasoline, of at least 87 on the AKI (anti-knock index), which is the average of the RON (research octane number) and MON (motor octane number) indices.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numerical values are assumed to be modified by the term “about” and in certain situations, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIGS. 1A, 1B, and 1C are cross-sectional schematic views of exemplary porous substrates and an asymmetric composite membranes of the present disclosure. The porous structure of the porous substrate is not to scale and not representative of the actual structure.

FIG. 2 is a perspective side view of a module that includes an exemplary composite membrane of the present disclosure.

FIG. 3 is an illustration of an exemplary fuel separation system that includes an exemplary composite membrane of the present disclosure.

FIG. 4 is an illustration of a vacuum pervaporation testing apparatus.

FIG. 5 is an SEM cross-section image (400× magnification) of PE2 (polyether sulfone substrate from Nanostone Water, formerly known as Sepro Membranes Inc., Oceanside, Calif.) substrate used in Examples 38-39. Layer 1 is the nanoporous layer, layer 2 is the microporous layer, and layer 3 is macroporous layer. Sample was freeze fractured in liquid nitrogen and imaged using Hitachi S4500 FESEM scanning electron microscope (SEM).

FIG. 6 is an SEM cross-section image of layers 1 and 2 of the substrate shown in FIG. 5 at 2000× magnification. Sample was freeze fractured in liquid nitrogen and imaged using Hitachi S4500 FESEM scanning electron microscope (SEM).

FIG. 7 is an SEM cross-section image of the PE2 substrate coated with polymeric ionomer (layer 4) at 3 microns thick as described in Sample 38. Sample was freeze fractured in liquid nitrogen and imaged using Hitachi S4500 FESEM scanning electron microscope (SEM).

FIG. 8 is an SEM cross-section image of a composite membrane prepared according to Example 41. Sample was freeze fractured in liquid nitrogen and imaged using Hitachi S4500 FESEM scanning electron microscope (SEM).

FIG. 9 is an SEM cross-section image of a composite membrane prepared according to Example 42. Sample was freeze fractured in liquid nitrogen and imaged using Hitachi S4500 FESEM scanning electron microscope (SEM).

FIG. 10 is an SEM cross-section image of a composite membrane prepared according to Example 45. Sample was freeze fractured in liquid nitrogen and imaged using Hitachi S4500 FESEM scanning electron microscope (SEM).

FIG. 11 is an SEM cross-section image of a composite membrane prepared according to Example 51. Sample was freeze fractured in liquid nitrogen and imaged using Hitachi S4500 FESEM scanning electron microscope (SEM).

### DETAILED DESCRIPTION OF ILLUSTRATIVE EMBODIMENTS

The present disclosure provides separation membranes that include a polymeric ionomer.

In certain embodiments, the polymeric ionomer can be a free-standing separation membrane.

In certain embodiments, the separation membranes are composite membranes (preferably, asymmetric composite membranes) that include a porous substrate and a polymeric ionomer. The porous substrate has opposite first and second major surfaces, and a plurality of pores. The polymeric ionomer may be disposed only in at least a portion of the plurality of pores (forming a pore-filling polymer layer), or the polymeric ionomer may be disposed on the surface (forming a top coating polymer layer), or the polymeric ionomer may be disposed both in and on the surface.

In certain embodiments in which the composite membranes are asymmetric composite membranes, the amount of the polymeric ionomer at, or adjacent to, the first major surface is greater than the amount of the polymeric ionomer at, or adjacent to, the second major surface. Hence, a composite membrane is asymmetric with respect to the amount of polymeric ionomer (pore-filling polymer) throughout the thickness of the porous substrate.

Such separation membranes may be used in various separation methods, including pervaporation, gas separation, vapor permeation, nanofiltration, organic solvent nanofiltration, and combinations thereof (e.g., a combination of pervaporation and vapor permeation).

Such separation methods may be used to separate a first fluid (i.e., liquid and/or vapor) from a feed mixture of a first fluid (i.e., liquid and/or vapor) and a second fluid (i.e., liquid and/or vapor). The first fluid may be a natural or inherent component of the second fluid, or the first fluid could be an additive in the second fluid. Either type of mixture may be a “feed mixture” as used herein.

The preferred separation membranes of the present disclosure are particularly useful in pervaporation methods to separate a first fluid (e.g., first liquid) from a feed mixture of a first fluid (e.g., first liquid) and a second fluid (e.g., second liquid).

In certain embodiments, separation membranes of the present disclosure are composite membranes and include a porous substrate (i.e., a support substrate which may be in the form of one or more porous layers) that includes opposite first and second major surfaces, and a plurality of pores; and a polymeric ionomer that forms a layer having a thickness in and/or on the porous substrate. In certain embodiments, the polymeric ionomer layer is preferably a continuous layer. The amount of the polymeric ionomer at, or adjacent to, the first major surface is greater than the amount of the polymeric ionomer at, or adjacent to, the second major surface in an asymmetric composite membrane.

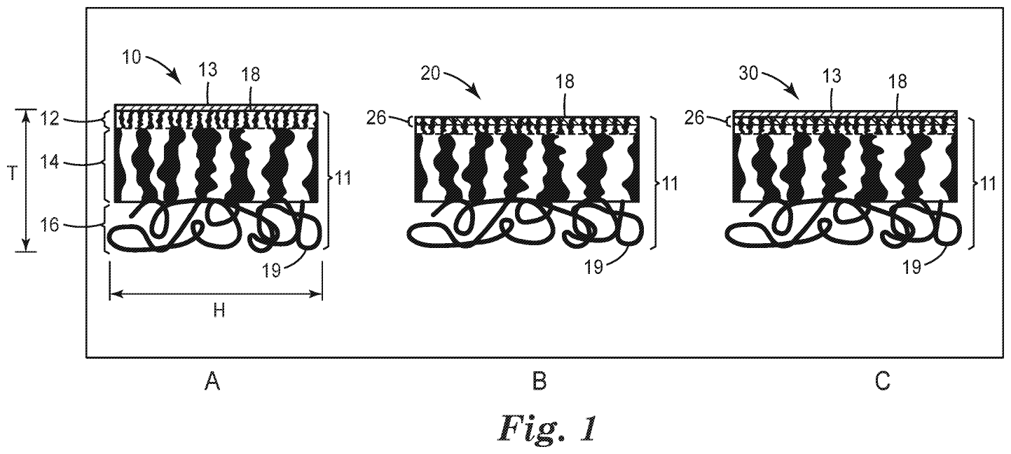

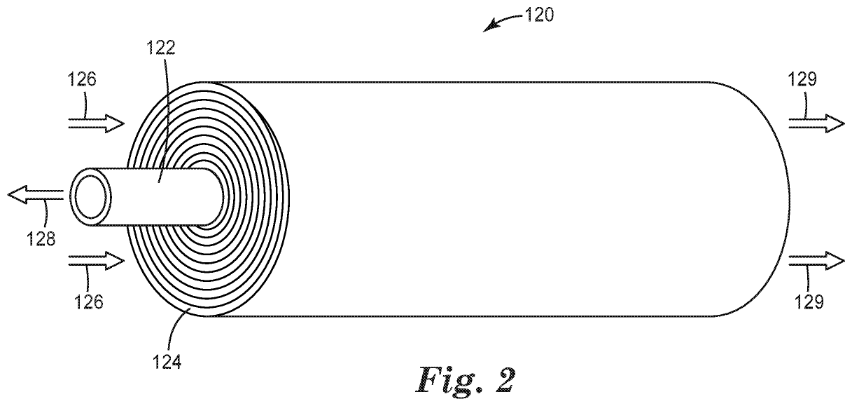

FIG. 1 provides illustrations of: a first exemplary asymmetric composite membrane 10 that includes a porous substrate 11 with polymeric ionomer coated only in a layer 13 on first major surface 18 of the porous substrate (FIG. 1A); a second exemplary asymmetric composite membrane 20 that includes porous substrate 11 with polymeric ionomer coated only in a portion of the pores of the porous substrate forming a pore-filling polymer layer 26 adjacent to major surface 18 (FIG. 1B); and an exemplary asymmetric composite membrane 30 with polymeric ionomer coated both in a layer 13 on first major surface 18 and in a portion of the pores of the porous substrate forming a pore-filling polymer layer 26 adjacent to major surface 18 (FIG. 1C), all shown in vertical cross-section.

The exemplary porous substrate 11 shown in FIG. 1 includes three layers that include a nanopororous layer 12, a microporous layer 14, and a macroporous layer 16 (FIG. 1A) having a first major surface 18 and a second major surface 19. It should be understood that a porous substrate suitable for use in the composite membranes of the present disclosure does not require either a nanoporous layer 12 or a macroporous layer 16.

In a porous substrate 11, the pores are interconnected vertically (i.e., throughout the thickness “T” of the porous substrate 11, see FIG. 1A). In certain preferred embodiments, the pores of the porous substrate 11 are interconnected horizontally (e.g., as in a microfiltration membrane) along dimension “H” (see FIG. 1A). In such embodiments, the pore-filling polymer layer 26 (FIGS. 1B and 1C) formed by the pore-filling polymeric ionomer is preferably a continuous layer. If the pores of the porous substrate 11 are not all interconnected horizontally (along dimension “H”), the layer 26 is discontinuous (i.e., the pore-filling polymer forms a plurality of discreet regions within the porous substrate). It will be understood that dimension “H” generally refers to the plane of the porous substrate and is exemplary of all the various horizontal dimensions within a horizontal slice of the substrate (shown in vertical cross-section). Whether layer 26 is continuous or discontinuous, for the asymmetric composite membrane, the amount of the pore-filling polymeric ionomer at, or adjacent to, the first major surface 18 is greater than the amount of the polymer at, or adjacent to, the second major surface 19.

Referring to FIG. 1A, the polymeric ionomer forms a coating 13 on (i.e., covers) the top surface 18 of the substrate 11. Referring to FIG. 1C, the polymeric ionomer forms a coating 13 on (i.e., covers) the top surface 18 of the substrate 11 in addition to being within the pores of the substrate forming layer 26. This coating layer 13 may be continuous or discontinuous.

Thus, in certain embodiments, the polymeric ionomer is in the form of a pore-filling polymer layer 26 (FIG. 1C) that forms at least a portion of the first major surface 18 of the porous substrate. In certain embodiments, the polymeric ionomer is in the form of a pore-filling polymer layer having an exposed major surface, which coats the first major surface of the porous substrate, and an opposite major surface disposed between the opposite first and second major surfaces of the porous substrate. In certain embodiments, the exposed major surface of the polymeric ionomer layer coats all the first major surface of the porous substrate.

As used herein, a continuous layer refers to a substantially continuous layer as well as a layer that is completely continuous. That is, as used herein, any reference to the polymeric ionomer layer coating or covering the first major surface of the porous substrate includes the polymeric ionomer layer coating all, substantially all, or only a portion of the first major surface of the porous substrate. The polymeric ionomer layer is considered to coat substantially all of the first major surface of the porous substrate (i.e., be substantially continuous), when enough of the first major surface of the porous substrate is coated such that the composite membrane is able to selectively separate (e.g., pervaporate) a desired amount of a first fluid (e.g., first liquid such as alcohol, or other high octane compounds such as aromatics) from a mixture of the first fluid (e.g., first liquid such as alcohol or other high octane compound) with a second fluid (e.g., second liquid such as gasoline or other such fuel). In particular, the flux and the selectivity of the separation membrane (with a “continuous layer” of polymeric ionomer) is sufficient for the particular system in which the membrane is used.

In certain embodiments, the polymeric ionomer layer (both layer 13 and/or pore-filling layer 26) has a thickness in the range of from 10 nm up to and including 50,000 nm (50 microns), or up to and including 20,000 nm. More specifically, the thickness of the polymeric ionomer layer may include, in increments of 1 nm, any range between 10 nm and 20,000 nm. For example, the thickness of the polymeric ionomer layer may be in the range of from 11 nm to 5999 nm, or 20 nm to 6000 nm, or 50 nm to 5000 nm, etc.

Separation membranes of the present disclosure may further include a (meth)acryl-containing polymer and/or an epoxy polymer. Such additional polymers provide improved durability and/or performance over the same separation membranes without either the (meth)acryl-containing polymer or epoxy polymer.

Separation membranes of the present disclosure may further include at least one of: (a) an ionic liquid mixed with the polymeric ionomer; or (b) an amorphous fluorochemical film disposed on the separation membrane, typically, on the side of the membrane the feed mixture enters. Such separation membranes demonstrate improved performance (e.g., flux) and/or durability over the same separation membranes without either the ionic liquid the amorphous fluorochemical film.

### Pervaporation

Pervaporation is a process that involves a membrane in contact with a liquid on the feed or upstream side and a vapor on the “permeate” or downstream side. Usually, a vacuum and/or an inert gas is applied on the vapor side of the membrane to provide a driving force for the process. Typically, the downstream pressure is lower than the saturation pressure of the permeate.

Vapor permeation is quite similar to pervaporation, except that a vapor is contacted on the feed side of the membrane instead of a liquid. As membranes suitable for pervaporation separations are typically also suitable for vapor permeation separations, use of the term “pervaporation” may encompass both “pervaporation” and “vapor permeation.”

Pervaporation may be used for dehydration of organic solvents, isolation of aroma compounds or components (i.e., odorants), and removal of volatile organic compounds from aqueous solutions. Pervaporation may be used also for separating and concentrating high octane compounds from a fuel mixture for use in “octane-on-demand” internal combustion engines. In certain embodiments of the present disclosure, the asymmetric composite membranes are used for pervaporating high octane compounds (e.g., alcohol and/or aromatics) from a mixture of gasoline and alcohol and/or aromatics. In certain embodiments of the present disclosure, the asymmetric composite membranes are used for pervaporating alcohol from an alcohol and gasoline mixture.

Separation membranes described herein are particularly useful for selectively pervaporating a first fluid (e.g., a first liquid such as high octane compounds) from a mixture that includes the first fluid (e.g., a first liquid such as high octane compounds) and a second fluid (e.g., a second liquid such as gasoline or other such fuels), generally because the polymeric ionomer is more permeable to the first fluid (e.g., first liquid) than the second fluid (e.g., second liquid).

In certain embodiments, the first liquid is a more polar liquid than the second liquid. The second liquid may be a nonpolar liquid.

In certain embodiments, the first liquid may be water, or an alcohol (such as ethanol, methanol, 1-propanol, 2-propanol, 1-methoxy-2-propanol, or butanol). In certain embodiments, the first liquid may be high octane compounds, such as an alcohol, or aromatic hydrocarbons (i.e., aromatics) such as toluene and xylene.

Some compounds may be removed because they are undesirable. Some compounds may be removed because they are desirable to form a separate concentrate for later use (e.g., high octane compounds such as aromatics). Thus, in certain embodiments, the first liquid may be a high octane compound, i.e., one having an octane rating of at least 87 (AKI) (e.g., ethanol and aromatics).

In certain embodiments, the second liquid may be gasoline or other such fuel. In certain embodiments, the first liquid is an alcohol, and the second liquid is gasoline. Thus, in one embodiment of the present disclosure, an asymmetric composite membrane for selectively pervaporating alcohol from an alcohol and gasoline feed mixture is provided. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to alcohol than gasoline.

In certain embodiments, the first liquid is an organic compound having an octane rating of at least 87, and the second liquid is a fuel (e.g., gasoline). Thus, in one embodiment of the present disclosure, an asymmetric composite membrane for selectively pervaporating a high octane compound from a fuel feed mixture that includes such high octane compounds is provided. This method results in separating and concentrating high octane compounds. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to the high octane compounds than the other components (e.g., low octane compounds) in the fuel.

Low octane compounds, i.e., those having an octane rating of less than 87 (AKI) include, for example, n-hexane, n-pentane, n-octane, n-nonane, n-dexane. High octane compounds, i.e., those having an octane rating of at least 87 (AKI) include, for example, methanol, ethanol, iso-butanol, as well as xylene, toluene, and other aromatics.

### Polymeric Ionomer

The polymeric ionomer has a highly fluorinated backbone and recurring pendant groups according to the following formula (Formula I):

—O—R_{f}—[—SO₂—N⁻(Z⁺)—SO₂—R—]ₘ—[SO₂]ₙ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4;
   m=0 to 6; and
   n=0 or 1;
   with the proviso that at least one of m or n must be non-zero.

The polymeric ionomer is more permeable to the first liquid than the second liquid.

In certain embodiments, m is not 0 when Q is —O⁻Y⁺.

In certain embodiments, Q is not —O⁻Y⁺ when m is 0.

In certain embodiments, when m=0 and Q is —O⁻Y⁺, the first liquid is alcohol and the second liquid is gasoline.

Herein, a “highly fluorinated” backbone (i.e., the longest continuous chain) is one that contains at least 40 weight percent (wt-%) fluorine, based on the total weight of the backbone.

The number of pendant groups can be determined by the equivalent weight of the polymeric ionomer. Equivalent weight (EW) is a measure of the total acid content of the ionomer and is defined as the grams of polymer per mole of acid or acid salt (g/mol). Lower equivalent weight polymers will have a higher total acid or acid salt content. Typically, in Formula I, the acid or salt groups are sulfonic acid (—SO₃⁻X⁺), sulfonimide (—SO₂N⁻(Z⁺)SO₂—), or sulfonamide (—SO₂NH₂).

In certain embodiments, the equivalent weight is at least 400 grams per mole (g/mol), or at least 600 g/mol, or at least 700 g/mol.

In certain embodiments, the equivalent weight is up to and including 1600 g/mol, or up to and including 1200 g/mol, or up to and including 1000 g/mol.

In Formula I, R_{f} is a perfluorinated organic linking group. In certain embodiments, R_{f} is —(CF₂)ₜ— wherein t is 1 to 6, or 2 to 4. In certain embodiments, R_{f} is —CF₂-[C(CF₃)F—O—CF₂—CF₂]—.

In Formula I, R is an organic linking group. R may be fluorinated (partially or fully) or nonfluorinated. R may be aromatic, aliphatic, or a combination thereof. In certain embodiments, R is a nonfluorinated aromatic group (e.g., phenyl). In certain embodiments R is an aliphatic group that is fluorinated, and optionally perfluorinated (e.g., —(CF₂)ᵣ— wherein r is 1 to 6, or 2 to 4).

In Formula I, Z⁺ is H⁺, a monovalent cation, or a multivalent cation. Examples of suitable monovalent cations include Li⁺, Na⁺, K⁺, Rb⁺, Cs⁺, and NR₄⁺ (wherein R is H or C1-4 alkyl groups). Examples of suitable multivalent cations include Be²⁺, Mg²⁺, Mn²⁺, Fe²⁺, Zn²⁺, Co²⁺, Cu²⁺, Fe³⁺, and Al³⁺.

In Formula I, Q is H, F, —NH₂, —O⁻Y⁺, or —CₓF₂ₓ₊₁.

In certain embodiments, Q is —O⁻Y⁺, and Y⁺ is H⁺, or a monovalent cation, or multivalent cation. Exemplary cations are as described above for Z⁺.

In certain embodiments, Q is —O⁻Y⁺, and Y⁺ is a monovalent cation or a multivalent cation. This is preferred in certain embodiments because PFSA ionomers are very strong acids due to the electron withdrawing effects of the perfluorinated alkyl group attached to the sulfonic acid group. When used as an ethanol separation membrane, this strong acid can catalyze the decomposition of compounds in the fuel mixture. Exchanging the reactive proton with lithium, sodium, magnesium or other mono or multivalent cations results in an ionic functionality that is no longer acidic and, therefore, no longer catalyzes this decomposition. Furthermore, the acid will become neutralized over time when exposed to minor amounts of base or cations that may be present in a fuel mixture. By using the ionomer in the salt (non-acid) form it is expected that the performance will be more stable over time.

In certain embodiments, Q is —CₓF₂ₓ₊₁, and x=1 to 4.

In Formula I, m=0 to 6, or 2 to 4.

In certain embodiments, at least one of m or n must be non-zero.

In certain embodiments, the polymeric ionomer has a highly fluorinated backbone and recurring pendant groups according to the following formula (Formula II):

—O—R_{f}—[SO₂]-Q
wherein:
   R_{f} is a perfluorinated organic linking group (as described above for Formula I);
   Q is —NH₂ or —O⁻Y⁺; and
   Y⁺ is H⁺, a monovalent cation, or a multivalent cation (as described above for Formula I);

with the proviso that when Q is —O⁻Y⁺, the first liquid is alcohol and the second liquid is gasoline.

### Examples of polymeric ionomers of Formula II include those described in U.S. Pat. No. 7,348,088, or commercially available from DuPont under the trade name NAFION.

In certain embodiments, the polymeric ionomer has a highly fluorinated backbone and recurring pendant groups according to the following formula (Formula III):

—O—R_{f}—[—SO₂—N⁻(Z⁺)—SO₂—R—]ₘ-Q
wherein:
   R_{f} is a perfluorinated organic linking group (as described above for Formula I)
   R is an organic linking group (as described above for Formula I);
   Z⁺ is H⁺, a monovalent cation, or a multivalent cation (as described above for Formula I);
   Q is H, F, —NH₂, —O⁻Y⁺, or —CₓF₂ₓ₊₁;
   Y⁺ is H⁺, a monovalent cation, or a multivalent cation (as described above for Formula I);
   x=1 to 4;
   m=1 to 6.

Examples of polymeric ionomers of Formula III include those described in U.S. Pat. Pub. No. 2013/0029249.

In certain embodiments, the polymeric ionomer is more permeable to a first liquid than a second liquid.

The polymeric ionomer may be crosslinked. The crosslinking may be physical crosslinking and/or chemical crosslinking such as, e.g., in the form of an interpenetrating network (IPN). The polymeric ionomer may be grafted to the porous (substrate) membrane (e.g., which may be in the form of a nanoporous layer). Or, it may be crosslinked and grafted to the porous substrate (e.g., nanoporous layer).

### Optional Substrate

In certain embodiments, the polymeric ionomer is a free-standing film. That is, the separation membrane is the polymeric ionomer with no supporting substrate. Thus, the polymeric ionomer is a free-standing membrane.

In certain embodiments, the polymeric ionomer forms a layer on the surface of a substrate, which may or may not be porous. Suitable substrates typically provide mechanical support for the polymeric ionomer. They may be in the form of films, membranes, fibers, foams, webs (e.g., knitted, woven, or nonwoven), etc.

The substrate may include one layer or multiple layers. For example, there may be two, three, four, or more layers.

In some embodiments, the substrate is hydrophobic. In other embodiments, the substrate is hydrophilic.

The materials that may be used in supporting substrates may be organic in nature (such as the organic polymers listed below), inorganic in nature (such as aluminum, steels, and sintered metals and/or ceramics and glasses), or a combination thereof. For example, the substrate may be formed from polymeric materials, ceramic and glass materials, metal, and the like, or combinations (i.e., mixtures and copolymers) thereof.

In separation membranes (e.g., composite membranes) of the present disclosure, materials that withstand hot gasoline environment and provide sufficient mechanical strength to the separation membranes are preferred. Materials having good adhesion to each other are particularly desirable.

In certain embodiments, the substrate is a porous substrate. In certain embodiments, it is preferably a polymeric porous substrate. In certain embodiments, it is preferably a ceramic porous substrate.

A porous substrate itself may be asymmetric or symmetric. If the porous substrate is asymmetric (before being combined with the polymeric ionomer), the first and second major surfaces have porous structures with different pore morphologies. For example, the porous substrate may have pores of differing sizes throughout its thickness. Analogously, if the porous substrate is symmetric (before being combined with the polymeric ionomer), the major surfaces have porous structures wherein their pore morphologies are the same. For example, the porous substrate may have pores of the same size throughout its thickness.

If the substrate is a porous substrate comprising opposite first and second major surfaces, and a plurality of pores, the polymeric ionomer forms a polymer layer having a thickness in and/or on the porous substrate. In certain embodiments, the polymer layer has a thickness in the range of from 10 nm up to and including 50 microns (50,000 nm).

In certain embodiments, the polymeric ionomer forms a layer on the surface of a porous substrate. In certain embodiments, the polymeric ionomer fills at least a portion of the pores of a porous substrate (i.e., the polymeric ionomer is a pore-filling polymer). In certain embodiments, the polymeric ionomer both fills at least a portion of the pores of a porous substrate and forms a layer on the surface of the porous substrate. Thus, the polymeric ionomer is not restricted within pores of a porous substrate in separation membranes of the present disclosure. In some embodiments, the polymeric ionomer forms an interpenetrating network with a second polymer network.

Referring to FIG. 1A, an asymmetric substrate is shown with different pore morphologies at the first major surface 18 and the second major surface 19. More specifically, there are three layers each of different pore size such that the overall substrate has pores of differing sizes throughout its thickness “T.” In certain embodiments, nanoporous layer 12 alone could function as the porous substrate. In such embodiments, the porous substrate would be symmetric.

Suitable porous substrates include, for example, films, porous membranes, woven webs, nonwoven webs, hollow fibers, and the like. For example, the porous substrates may be made of one or more layers that include films, porous films, micro-filtration membranes, ultrafiltration membranes, nanofiltration membranes, woven materials, and nonwoven materials.

Suitable polymeric materials for use in the supporting substrate of a separation membrane of the present disclosure include, for example, polystyrene, polyolefins, polyisoprenes, polybutadienes, fluorinated polymers (e.g., polyvinylidene fluoride (PVDF), ethylene-co-chlorotrifluoroethylene copolymer (ECTFE), polytetrafluoroethylene (PTFE)), polyvinyl chlorides, polyesters (PET), polyamides (e.g., various nylons), polyimides, polyethers, poly(ether sulfone)s, poly(sulfone)s, poly(phenylene sulfone)s, polyphenylene oxides, polyphenylene sulfides (PPS), poly(vinyl acetate)s, copolymers of vinyl acetate, poly(phosphazene)s, poly(vinyl ester)s, poly(vinyl ether)s, poly(vinyl alcohol)s, polycarbonates, polyacrylonitrile, polyethylene terephthalate, cellulose and its derivatives (such as cellulose acetate and cellulose nitrate), and the like, or combinations (i.e., mixtures or copolymers) thereof.

Suitable polyolefins include, for example, poly(ethylene), poly (propylene), poly(1-butene), copolymers of ethylene and propylene, alpha olefin copolymers (such as copolymers of 1-butene, 1-hexene, 1-octene, and 1-decene), poly(ethylene-co-1-butene), poly(ethylene-co-1-butene-co-1-hexene), and the like, or combinations (i.e., mixtures or copolymers) thereof.

Suitable fluorinated polymers include, for example, polyvinylidene fluoride (PVDF), polyvinyl fluoride, copolymers of vinylidene fluoride (such as poly(vinylidene fluoride-co-hexafluoropropylene)), copolymers of chlorotrifluoroethylene (such as ethylene-co-chlorotrifluoroethylene copolymer), polytetrafluoroethylene, and the like, or combinations (i.e., mixtures or copolymers) thereof.

Suitable polyamides include, for example, poly(imino(1-oxohexamethylene)), poly(iminoadipoylimino hexamethylene), poly(iminoadipoyliminodecamethylene), polycaprolactam, and the like, or combinations thereof.

Suitable polyimides include, for example, poly(pyromellitimide), polyetherimide, and the like.

Suitable poly(ether sulfone)s include, for example, poly(diphenylether sulfone), poly(diphenylsulfone-co-diphenylene oxide sulfone), and the like, or combinations thereof.

Suitable polyethers include, for example, polyetherether ketone (PEEK).

In certain embodiments, particularly for the optional (meth)acryl-containing materials described herein, substrate materials may be photosensitive or non-photosensitive. Photosensitive porous substrate materials may act as a photoinitiator and generate radicals which initiate polymerization under radiation sources, such as UV radiation, so that the optional (meth)acryl-containing polymerizable material could covalently bond to the porous substrate. Suitable photosensitive materials include, for example, polysulfone, polyethersulfone, polyphenylenesulfone, PEEK, polyimide, PPS, PET, and polycarbonate. Photosensitive materials are preferably used for nanoporous layers.

Suitable porous substrates may have pores of a wide variety of sizes. For example, suitable porous substrates may include nanoporous membranes, microporous membranes, microporous nonwoven/woven webs, microporous woven webs, microporous fibers, nanofiber webs and the like. In some embodiments, the porous substrate may have a combination of different pore sizes (e.g., micropores, nanopores, and the like). In one embodiment, the porous substrate is microporous.

In some embodiments, the porous substrate includes pores that may have an average pore size less than 10 micrometers (μm). In other embodiments, the average pore size of the porous substrate may be less than 5 μm, or less than 2 μm, or less than 1 μm.

In other embodiments, the average pore size of the porous substrate may be greater than 10 nm (nanometer). In some embodiments, the average pore size of the porous substrate is greater than 50 nm, or greater than 100 nm, or greater than 200 nm.

In certain embodiments, the porous substrate includes pores having an average size in the range of from 0.5 nm up to and including 1000 μm. In some embodiments, the porous substrate may have an average pore size in a range of 10 nm to 10 μm, or in a range of 50 nm to 5 μm, or in a range of 100 nm to 2 μm, or in a range of 200 nm to 1 μm.

In certain embodiments, the porous substrate includes a nanoporous layer. In certain embodiments, the nanoporous layer is adjacent to or defines the first major surface of the porous substrate. In certain embodiments, the nanoporous layer includes pores having a size in the range of from 0.5 nanometer (nm) up to and including 100 nm. In accordance with the present disclosure, the size of the pores in the nanoporous layer may include, in increments of 1 nm, any range between 0.5 nm and 100 nm. For example, the size of the pores in the nanoporous layer may be in the range of from 0.5 nm to 50 nm, or 1 nm to 25 nm, or 2 nm to 10 nm, etc. Molecular Weight Cut-Off (MWCO) is typically used to correlate to the pore size. That is, for nanopores, the molecular weight of a polymer standard (retain over 90%) such as dextran, polyethylene glycol, polyvinyl alcohol, proteins, polystyrene, poly(methyl methacrylate) may be used to characterize the pore size. For example, one supplier of the porous substrates evaluates the pore sizes using a standard test, such as ASTM E1343-90-2001 using polyvinyl alcohol.

In certain embodiments, the porous substrate includes a microporous layer. In certain embodiments, the microporous layer is adjacent to or defines the first major surface of the porous substrate. In certain embodiments, the microporous layer includes pores having a size in the range of from 0.01 μm up to and including 20 μm. In accordance with the present disclosure, the size of the pores in the microporous layer may include, in increments of 0.05 μm, any range between 0.01 μm up and 20 μm. For example, the size of the pores in the microporous layer may be in the range of from 0.05 μm to 10 μm, or 0.1 μm to 5 μm, or 0.2 μm to 1 μm, etc. Typically, the pores in the microporous layer may be measured by mercury porosimetry for average or largest pore size, bubble point pore size measurement for the largest pores, Scanning Electron Microscopy (SEM) and/or Atom Force Microscopy (AFM) for the average/largest pore size.

In certain embodiments, the porous substrate includes a macroporous layer. In certain embodiments, the macroporous layer is adjacent to or defines the first major surface of the porous substrate. In certain embodiments, the macroporous layer is embedded between two microporous layers, for example a BLA020 membrane obtained from 3M Purification Inc.

In certain embodiments, the macroporous layer comprises pores having a size in the range of from 1 μm and 1000 μm. In accordance with the present disclosure, the size of the pores in the macroporous layer may include, in increments of 1 μm, any range between 1 μm up to and including 1000 μm. For example, the size of the pores in the macroporous substrate may be in the range of from 1 μm to 500 μm, or 5 μm to 300 μm, or 10 μm to 100 μm, etc. Typically, the size of the pores in the macroporous layer may be measured by Scanning Electron Microscopy, or Optical Microscopy, or using a Pore Size Meter for Nonwovens.

The macroporous layer is typically preferred at least because the macropores not only provide less vapor transport resistance, compared to microporous or nanoporous structures, but the macroporous layer can also provide additional rigidity and mechanical strength.

The thickness of the porous substrate selected may depend on the intended application of the membrane. Generally, the thickness of the porous substrate (“T” in FIG. 1A) may be greater than 10 micrometers (μm). In some embodiments, the thickness of the porous substrate may be greater than 1,000 μm, or greater than 5,000 μm. The maximum thickness depends on the intended use, but may often be less than or equal to 10,000 μm.

In certain embodiments, the porous substrate has first and second opposite major surfaces, and a thickness measured from one to the other of the opposite major surfaces in the range of from 5 μm up to and including 500 μm. In accordance with the present disclosure, the thickness of the porous substrate may include, in increments of 25 μm, any range between 5 μm and 500 μm. For example, the thickness of the porous substrate may be in the range of from 50 μm to 400 μm, or 100 μm to 300 μm, or 150 μm to 250 μm, etc.

In certain embodiments, the nanoporous layer has a thickness in the range of from 0.01 μm up to and including 10 μm. In accordance with the present disclosure, the thickness of the nanoporous layer may include, in increments of 50 nm, any range between 0.01 μm and 10 μm. For example, the thickness of the nanoporous layer may be in the range of from 50 nm to 5000 nm, or 100 nm to 3000 nm, or 500 nm to 2000 nm, etc.

In certain embodiments, the microporous layer has a thickness in the range of from 5 μm up to and including 300 μm. In accordance with the present disclosure, the thickness of the microporous layer may include, in increments of 5 μm, any range between 5 μm and 300 μm. For example, the thickness of the microporous layer may be in the range of from 5 μm to 200 μm, or 10 μm to 200 μm, or 20 μm to 100 μm, etc.

In certain embodiments, the macroporous layer has a thickness in the range of from 25 μm up to and including 500 μm. In accordance with the present disclosure, the thickness of the macroporous layer may include, in increments of 25 μm, any range between 25 μm up and 500 μm. For example, the thickness of the macroporous substrate may be in the range of from 25 μm to 300 μm, or 25 μm to 200 μm, or 50 μm to 150 μm, etc.

In certain embodiments, there may be anywhere from one to four layers in any combination within a porous substrate. The individual thickness of each layer may range from 5 nm to 1500 μm in thickness.

In certain embodiments, each layer may have a porosity that ranges from 0.5% up to and including 95%.

Optional (Meth)acryl-containing and/or Epoxy Additives

Separation membranes of the present disclosure may further include a (meth)acryl-containing polymer (i.e., (meth)acrylate polymer) and/or an epoxy polymer. In certain embodiments, such separation membranes demonstrate improved durability over the same separation membranes without the (meth)acryl-containing polymer or epoxy polymer. Improved durability may be demonstrated by reduced mechanical damage (e.g., abrasions, scratches, or erosion, or crack generation upon membrane folding)), reduced fouling, and/or reduced chemical attack.

In certain embodiments, the (meth)acryl-containing polymer and/or epoxy polymer may be mixed with the polymeric ionomer. They may form an interpenetrating network within the polymeric ionomer.

In certain embodiments, the (meth)acryl-containing polymer and/or epoxy polymer form separate layers from that of the polymeric ionomer. For example, the (meth)acryl-containing polymer may be a pore-filling polymer in the porous substrate and the polymeric ionomer may be coated on top of the porous substrate. Similarly, the epoxy polymer may be a pore-filling polymer in the porous substrate and the polymeric ionomer may be coated on top of the porous substrate. Membranes made using such multi-layered coatings are referred to herein as hybrid membranes.

In certain embodiments, the starting materials for the (meth)acryl-containing polymer (which refers to acrylate and methacrylate polymers) include (meth)acryl-containing monomers and/or oligomers. Suitable (meth)acryl-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, and 2-acrylamido-2-methylpropanesulfonic acid (AMPS). Various combinations of such monomers and/or oligomers may be used to form the pore-filling polymer.

In certain embodiments, the (meth)acryl-containing monomers and/or oligomers may be selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, and a polyester tetra-acrylate. Various combinations of such monomers and/or oligomers may be used to form the pore-filling polymer.

In certain embodiments, the starting monomers and/or oligomers include one or more of the following:
(a) di(meth)acryl-containing compounds such as dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate;
(b) tri(meth)acryl-containing compounds such as trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), and trimethylolpropane triacrylate;
(c) higher functionality (meth)acryl-containing compounds (i.e., higher than tri-functional) such as ditrimethylolpropane tetraacrylate, dipentaerythritol pentaacrylate, ethoxylated (4) pentaerythritol tetraacrylate, pentaerythritol tetraacrylate, and caprolactone modified dipentaerythritol hexaacrylate;
(d) oligomeric (meth)acryl compounds such as, for example, urethane acrylates, polyester acrylates, epoxy acrylates, silicone acrylates, polyacrylamide analogues of the foregoing, and combinations thereof (such compounds are widely available from vendors such as, for example, Sartomer Company, Exton, PA, UCB Chemicals Corporation, Smyrna, GA, and Aldrich Chemical Company, Milwaukee, Wis.);
(e) perfluoroalkyl meth(acryl)-containing compounds such as 1H,1H,6H,6H-perfluorohydroxyldiacrylate, 1H,1H-2,2,3,3,4,4,4-heptafluorobutyl acrylate, and perfluorocyclohexyl)methyl acrylate;
(f) charged meth(acryl)-containing compounds such as acrylic acid, 2-acrylamido-2-methylpropanesulfonic acid (AMPS), and [3-(methacryloylamino)propyl]trimethylammonium chloride solution; and
(g) polar (meth)acrylate compounds such as 2-hydroxyethyl(meth)acrylate (HEMA) and glycerol methacrylate.

In certain embodiments, the epoxy polymers include those formed from one or more epoxy resin(s) and one or more curing agents. The epoxy has the general Formula IV:

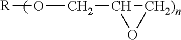

wherein: R includes one or more aliphatic groups, cycloaliphatic groups, and/or aromatic hydrocarbon groups, optionally wherein R further includes at least one ether linkage between adjacent hydrocarbon groups; and n is an integer greater than 1. Generally, n is the number of glycidyl ether groups and must be greater than 1 for at least one of the first epoxy resins of Formula I present in the adhesive. In some embodiments, n is 2 to 4.

Curing agents are compounds which are capable of crosslinking the epoxy resin. Typically, these agents are primary and/or secondary amines. The amines may be aliphatic, cycloaliphatic, or aromatic. In some embodiments, useful amine curing agents include those having the general Formula V:

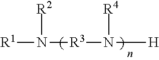

wherein: R¹, R², and R⁴ are independently selected from hydrogen, a hydrocarbon containing 1 to 15 carbon atoms, and a polyether containing up to 15 carbon atoms; R³ represents a hydrocarbon containing 1 to 15 carbon atoms or a polyether containing up to 15 carbon atoms; and n is from 2 to 10.

Exemplary epoxy resins include glycidyl ethers of bisphenol A, bisphenol F, and novolac resins as well as glycidyl ethers of aliphatic or cycloaliphatic diols. Examples of commercially available glycidyl ethers include polyglycerol polyglycidyl ether from Nagase Chemtex, Tokyo, Japan under the trade name of EX-512, EX521, sorbitol polyglycidyl ether from Nagase Chemtex Corp. Tokyo, Japan under the trade name of EX614B, diglycidylethers of bisphenol A (e.g., those available under the trade names EPON 828, EPON 1001, EPON 1310 and EPON 1510 from Hexion Specialty Chemicals GmbH, Rosbach, Germany, those available under the trade name D.E.R. from Dow Chemical Co. (e.g., D.E.R. 331, 332, and 334)

Examples of amine curing agents include ethylene amine, ethylene diamine, diethylene diamine, propylene diamine, hexamethylene diamine, 2-methyl-1,5-pentamethylene-diamine, triethylene tetramine (“TETA”), tetraethylene pentamine (“TEPA”), hexaethylene heptamine, and the like. Commercially available amine curing agents include those available from Air Products and Chemicals, Inc. under the trade name ANC AMINE. At least one of the amine curing agents is a polyether amine having one or more amine moieties, including those polyether amines that can be derived from polypropylene oxide or polyethylene oxide. Suitable polyether amines that can be used include those available from Huntsman under the trade name JEFFAMINE, and from Air Products and Chemicals, Inc. under the trade name ANCAMINE. Suitable commercially available polyetheramines include those sold by Huntsman under the JEFFAMINE trade name. Suitable polyether diamines include JEFFAMINEs in the D, ED, and DR series. These include JEFFAMINE D-230, D-400, D-2000, D-400, HK-511, ED- 600, ED-900, ED-2003, EDR-148, and EDR-176. Suitable polyether triamines include JEFFAMINEs in the T series. These include JEFFAMINE T-403, T-3000, and T-5000.

### Optional Ionic Liquids

In certain embodiments, separation membranes of the present disclosure further include one or more ionic liquids mixed with one or more the polymeric ionomers.

Such composite membranes demonstrate improved performance (e.g., flux) over the same separation membranes without the ionic liquids. Improved performance may be demonstrated by increased flux while maintaining good high octane compound (e.g., alcohol such as ethanol) selectivity.

An ionic liquid (i.e., liquid ionic compound) is a compound that is a liquid under separation conditions. It may or may not be a liquid during mixing with the polymeric ionomer, application to a substrate, storage, or shipping. In certain embodiments, the desired liquid ionic compound is liquid at a temperature of less than 100° C., and in certain embodiments, at room temperature.

Ionic liquids are salts in which the cation(s) and anion(s) are poorly coordinated. At least one of the ions is organic and at least one of the ions has a delocalized charge. This prevents the formation of a stable crystal lattice, and results in such materials existing as liquids at the desired temperature, often at room temperature, and at least, by definition, at less than 100° C.

In certain embodiments, the ionic liquid includes one or more cations selected from quaternary ammonium, imidazolium, pyrazolium, oxazolium, thiazolium, triazolium, pyridinium, piperidinium, pyridazinium, pyrimidinium, pyrazinium, pyrrolidinium, phosphonium, trialkylsulphonium, pyrrole, and guanidium.

In certain embodiments, the ionic liquid includes one or more anions selected from Cl⁻, Br⁻, I⁻, HSO₄⁻, NO₃⁻, SO₄²⁻, CF₃SO₃₋, N(SO₂CF₃)₂₋, CH₃SO₃₋, B(CN)₄₋, C₄F₉SO₃₋, PF₆₋, N(CN)₄₋, C(CN)₄⁻, BF₄⁻, Ac⁻, SCN⁻, HSO₄⁻, CH₃SO₄⁻, C₂H₅SO₄⁻, and C₄H₉SO₄⁻.

In certain embodiments, the ionic liquid is selected from 1-ethyl-3-methyl imidazolium tetrafluoroborate (Emim-BF₄), 1-ethyl-3-methyl imidazolium trifluoromethane sulfonate (Emim-TFSA), 3-methyl-N-butyl-pyridinium tetrafluoroborate, 3-methyl-N-butyl-pyridinium trifluoromethanesulfonate, N-butyl-pyridinium tetrafluoroborate, 1-butyl-2,3-dimethylimidazolium tetrafluoroborate, 1-butyl-2,3-dimethylimidazolium trifluoromethanesulfonate, 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium iodide, 1-butyl-3-methylimidazolium nitrate, 1-ethyl-3-methylimidazolium bromide, 1-ethyl-3-methylimidazolium iodide, 1-ethyl-3-methylimidazolium nitrate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethylsulfate, 1-butyl-3-methylimidazolium acetate, 1-butyl-3-methylimidazolium trifluoroacetate, 1-butyl-3-methyl imidazolium bis(trifluormethylsulfonyl)imide (Bmim-Tf₂N), and combinations thereof.

### Optional Fluorochemical Films

In certain embodiments, composite membranes of the present disclosure further include an amorphous fluorochemical film disposed on the separation membrane. Typically, the film is disposed on the side of the separation membrane the feed mixture enters. It is possible, however, to include an amorphous fluorochemical film on both major surfaces of the separation membrane to further protect the polymeric ionomer.

In certain embodiments, amorphous fluorochemical film is deposited on top of the porous substrate so as to protect the pore-filling polymer. The amorphous fluorochemical film may fill a portion of the porous substrate's pores above the pore-filling polymer.

In certain embodiments, such separation membranes demonstrate improved durability over the same separation membranes without the amorphous fluorochemical film. Improved durability may be demonstrated by reduced mechanical damage (e.g., abrasions, scratches, or erosion, or crack generation upon membrane folding), reduced fouling, reduced chemical attack, and/or reduced performance decline after exposure to gasoline or ethanol/gasoline mixture under separation conditions.

In certain embodiments, such separation membranes demonstrate improved performance over the same separation membranes without the amorphous fluorochemical film. Improved performance may be demonstrated by increased flux.

In certain embodiments, such amorphous fluorochemical film typically has a thickness of at least 0.001 μm, or at least 0.03 μm. In certain embodiments, such amorphous fluorochemical film typically has a thickness of up to and including 5 μm, or up to and including 0.1 μm.

In certain embodiments, the amorphous fluorochemical film is a plasma-deposited fluorochemical film, as described in U.S. Pat. Pub. 2003/0134515.

In certain embodiments, the plasma-deposited fluorochemical film is derived from one or more fluorinated compounds selected from: linear, branched, or cyclic saturated perfluorocarbons; linear, branched, or cyclic unsaturated perfluorocarbons; linear, branched, or cyclic saturated partially fluorinated hydrocarbons; linear, branched, or cyclic unsaturated partially fluorinated hydrocarbons; carbonyl fluorides; perfluorohypofluorides; perfluoroether compounds; oxygen-containing fluorides; halogen fluorides; sulfur-containing fluorides; nitrogen-containing fluorides; silicon-containing fluorides; inorganic fluorides (such as aluminum fluoride and copper fluoride); and rare gas-containing fluorides (such as xenon difluoride, xenon tetrafluoride, and krypton hexafluoride).

In certain embodiments, the plasma-deposited fluorochemical film is derived from one or more fluorinated compounds selected from CF₄, SF₆, C₂F₆, C₃F₈, C₄F₁₀, C₅F₁₂, C₆F₁₄, C₇F₁₆, C₈F₁₈, C₂F₄, C₃F₆, C₄F₈, C₅F₁₀, C₆F₁₂, C₄F₆, C₇F₁₄, C₈F₁₆, CF₃COF, CF₂(COF)₂, C₃F₇COF, CF₃OF, C₂F₅OF, CF₃COOF, CF₃OCF₃, C₂F₅OC₂F₅, C₂F₄OC₂F₄, OF₂, SOF₂, SOF₄, NOF, ClF₃, IF₅, BrF₅, BrF₃, CF₃I, C₂F₅I, N₂F₄, NF₃, NOF₃, SiF₄, SiF₄, Si₂F₆, XeF2, XeF₄, KrF₂, SF₄, SF₆, monofluorobenzene, 1,2-difluorobenzene, 1,2,4-trifluorobenzene, pentafluorobenzene, pentafluoropyridine, and pentafluorotolenene.

In certain embodiments, the plasma-deposited fluorochemical film is derived from one or more hydrocarbon compounds in combination with one or more fluorinated compounds. Examples of suitable hydrocarbon compounds include acetylene, methane, butadiene, benzene, methylcyclopentadiene, pentadiene, styrene, naphthalene, and azulene.

Typically, fluorocarbon film plasma deposition occurs at rates ranging from 1 nanometer per second (nm/sec) to 100 nm/sec depending on processing conditions such as pressure, power, gas concentrations, types of gases, and the relative size of the electrodes. In general, deposition rates increase with increasing power, pressure, and gas concentration. Plasma is typically generated with RF electric power levels of at least 500 watts and often up to and including 8000 watts, with a typical moving web speed or at least 1 foot per minute (fpm) (0.3 meters per minute (m/min)) and often up to and including 300 fpm (90 m/min). The gas flow rates, e.g., of the fluorinated compound and the optional hydrocarbon compound, is typically at least 10 (standard cubic centimeters per minutes) sccm and often up to and including 5000 sccm. In some embodiment, the fluorinated compound is carried by an inert gas such as argon, nitrogen, helium, etc.

In certain embodiments, the amorphous fluorochemical film includes an amorphous glassy perfluoropolymer having a Tg (glass transition temperature) of at least 100° C.

Examples of suitable amorphous glassy perfluoropolymers include a copolymer of perfluoro-2,2-dimethyl-1,3-dioxole (PDD) and polytetrafluoroethylene (TFE) (such as those copolymers available under the trade names TEFLON AF2400 and TEFLON AF1600 from DuPont Company), a copolymer of 2,2,4-trifluoro-5-trifluoromethoxy-1,3-dioxole (TTD) and TFE (such as those copolymers available under the trade names HYFLON AD60 and HYFLON AD80 from Solvay Company), and a copolymer of TFE and cyclic perfluoro-butenylvinyl ether (such as the copolymer available under the trade name CYTOP from Asahi Glass, Japan).

In certain embodiments, such amorphous glassy perfluoropolymer is a perfluoro-dioxole homopolymer or copolymer such as a copolymer of perfluoro-2,2-dimethyl-1,3-dioxole (PDD) and polytetrafluoroethylene (TFE), and a copolymer of 2,2,4-trifluoro-5-trifluoromethoxy-1,3-dioxole (TTD) and TFE.

In certain embodiments, such amorphous glassy perfluoropolymer is deposited out of solution. Exemplary solvents for use in deposition of the amorphous glassy perfluoropolymer include those available from 3M Company under the trade names FLUORINERT FC-87, FC-72, FC-84, and FC-770, as well as NOVEC HFE-7000, HFE-7100, HFE-7200, HFE-7300, and FIFE-7500.

### Methods of Making Separation Membranes

The polymeric ionomer and optional additives described herein are typically applied out of a solution or dispersion in a suitable amount of a liquid (e.g., deionized water or organic solvents). If an organic solvent is used, it may include methanol, ethanol, propanol, isopropanol, dibutyl sebecate, glycerol triacetate, acetone, methyl ethyl ketone, and 1-methoxy-2-propanol, etc.

By careful selection of the concentration of the coating solution or dispersion, the particle size and/or molecular weight of the polymeric ionomer, and the substrate pore structure so that the polymeric ionomer remains substantially on the surface, or penetrates substrate pores, or a combination of both, can be controlled. Subsequent drying, curing (e.g., by UV or e-beam irradiation), crosslinking, or grafting all the applied material is preferred so that only an insignificant amount is washed out and wasted.

If a curable pore-filling polymer composition (i.e., “pore-filling polymer coating solution” or simply “pore-filling coating solution”) is used for optional material (e.g., using curable (meth)acrylates), such coating composition may be prepared using one or more monomers and/or oligomers with optional additives in a suitable amount of a liquid (e.g., deionized water or organic solvents). If an organic solvent is used may include methanol, ethanol, propanol, isopropanol, dibutyl sebecate, glycerol triacetate, acetone, methyl ethyl ketone, 1-methoxy-2-propanol, etc.). Preferably, it is a volatile organic solvent for easy solution saturation or diffusion into the pores.

The pore-filling coating solution may be applied to a selected porous substrate by a variety of techniques such as saturation or immersion techniques (e.g., dip coating), knife coating, slot coating, slide coating, curtain coating, rod or bar coating, roll coating, gravure coating, spin coating, spraying coating. Monomer and/or oligomer concentration may range from 0.5% to 100%. For example, a porous substrate may be saturated in a pore-filling coating solution of monomers and/or oligomers of a pore-filling polymer in deionized water. Typically, the substrate may be separated from the liquid (e.g., volatile organic solvent) before or after irradiation. Preferably, upon removal from the solution, the substrate may be exposed to irradiation, such as UV irradiation. This can be done for example, on a moving belt. Any uncured pore-filling coating solution may be washed away, and then the composite membrane dried.

Either an ionic liquid can be mixed in the coating composition and applied to the porous support at one pass, or an ionic liquid dissolved in a solvent can be over-coated onto the polymeric ionomer coated membrane. The ionic liquid may diffuse into the polymeric ionomer layer.

An amorphous fluorocarbon film may be applied after the polymeric ionomer composition is coated in or on a substrate. The fluorocarbon film can be formed out of a solution or deposited by plasma fluorination.

Commercially available porous substrates may be supplied with a humectant, such as glycerol, that fills and/or coats the pores of the substrate. Typically, this is done to prevent small pores from collapsing during drying process and storage, for example. This humectant may or may not be washed out before using. Preferably, a substrate is obtained and used without a humectant. Commercially available porous substrates also may be supplied as wet with water and/or preservative(s). Preferably, a dry substrate is used.

### Uses

Separation membranes of the present disclosure, which may be composite membranes, particularly asymmetric composite membranes, may be used in various separation methods. Such separation methods include pervaporation, vapor permeation, gas separation, nanofiltration, organic solvent nanofiltration, and combinations thereof (e.g., a combination of pervaporation and vapor permeation). The separation membranes of the present disclosure are particularly useful in pervaporation methods. Pervaporation may be used for dehydration of organic solvents, isolation of aroma components, and removal of volatile organic compounds from aqueous solutions.

Preferred methods of the present disclosure involve use of the separation membranes, which may be composite membranes, particularly asymmetric composite membranes, in pervaporation, particularly pervaporating alcohol from an alcohol and gasoline mixture, or other high octane compounds (those organic compounds having an octane rating of at least 87 (AKI)) from a fuel that includes such high octane compounds (e.g., gasoline). This latter method results in concentrating high octane compounds for later use.

Well-known separation techniques may be used with the composite membranes of the present disclosure. For example, nanofiltration techniques are described in U.S. Pat. Pub. No. 2013/0118983 (Linvingston et al.), U.S. Pat. No. 7,247,370 (Childs et al.), and U.S. Pat. Pub. No. 2002/0161066 (Remigy et al.). Pervaporation techniques are described in U.S. Pat. No. 7,604,746 (Childs et al.) and EP 0811420 (Apostel et al.). Gas separation techniques are described in Journal of Membrane Sciences, vol. 186, pages 97-107 (2001).

Pervaporation separation rate is typically not constant during a depletion separation. The pervaporation rate is higher when the feed concentration of the selected material is higher than near the end of the separation when the feed concentration of the selected material is lower and this rate is typically not linear with concentration. At high feed concentration the separation rate is high and the feed concentration of the selected material and flux falls rapidly, but this concentration and flux changes very slowly as the limit of depletion is reached.

Typical conditions used in separation methods of the present disclosure include fuel temperatures of from −20° C. (or from 20° C. or room temperature) up to and including 120° C. (or up to and including 95° C.), fuel pressures of from 10 pounds per square inch (psi) (69 kPa) up to and including 400 psi (2.76 MPa) (or up to and including 100 psi (690 kPa)), fuel flow rates of 0.1 liter per minute (L/min) up to and including 20 L/min, and vacuum pressures from 20 Torr (2.67 kPa) to and including ambient pressure (i.e., 760 Torr (101 kPa)).

The performance of a separation membrane is mainly determined by the properties of the polymeric ionomer.

The efficiency of a pervaporation membrane may be expressed as a function of its selectivity and of its specific flux. The selectivity is normally given as the ratio of the concentration of the better permeating component to the concentration of the poorer permeating component in the permeate, divided by the corresponding concentration ratio in the feed mixture to be separated:

α=(y_{w}/yᵢ)/(x_{w}/xᵢ)

wherein y_{w} and yᵢ are the content of each component in the permeate, and x_{w} and xᵢ are the content of each component in the feed, respectively. Sometimes, the permeate concentration is defined as the separation efficiency if the feed component is relatively consistent.

The trans-membrane flux is a function of the composition of the feed. It is usually given as permeate amount per membrane area and per unit time, e.g., kilogram per meter squared per hour (kg/m² /hr).

In certain embodiments of the present disclosure, the polymeric ionomer exhibits a high octane compound (e.g., an alcohol) selectivity in the range of from at least 30% up to and including 100%. In this context, “high octane compound selectivity” (e.g., “alcohol selectivity”) means the amount of high octane compound (e.g., alcohol) in the gasoline (or other such fuel)/high octane compound (e.g., alcohol) mixture that diffuses through to the output side of the separation membrane. In accordance with the present disclosure, the high octane compound (e.g., alcohol) selectivity of the polymeric ionomer may include, in increments of 1%, any range between 30% and 100%. For example, the alcohol selectivity may be in the range of from 31% up to 99%, or 40% to 100%, or 50% to 95%, etc.

In certain embodiments, the polymeric ionomer in the separation membrane exhibits an average high octane compound (e.g., alcohol) permeate flux, e.g., from a high octane compound/fuel mixture (e.g., an alcohol/gasoline mixture) in the range of from at least 0.2 kg/m²/hr (in certain embodiments, at least 0.3 kg/m²/hr), and in increments of 10 g/m²/hr, up to and including 30 kg/m²/hr. For example the average ethanol flux from E10 (10% ethanol) to E2 (2% ethanol) standard include in the range of from 0.2 kg/m²/hr to 20 kg/m²/hr. Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 10 psi (69 kPa) up to and including 400 psi (2.76 MPa) (or up to and including 100 psi (690 kPa)). For example, these processing conditions would be suitable for an alcohol (e.g., ethanol) concentration in feed gasoline of from 2% up to and including 20%.

In certain embodiments of the present disclosure, the polymeric ionomer in the separation membrane can exhibit an average high octane compound (e.g., ethanol) permeate flux, in increments of 10 g/m²/hour, between the below-listed upper and lower limits (according to Method 1 and/or Method 2 in the Examples Section). In certain embodiments, the average high octane compound (e.g., alcohol such as ethanol) permeate flux may be at least 100 g/m²/hour, or at least 150 g/m²/hour, or at least 200 g/m²/hour, or at least 250 g/m²/hour, or at least 300 g/m²/hour, or at least 350 g/m²/hour, or at least 400 g/m²/hour, or at least 450 g/m²/hour, or at least 500 g/m²/hour, or at least 550 g/m²/hour, or at least 600 g/m²/hour, or at least 650 g/m²/hour, or at least 700 g/m²/hour, or at least 750 g/m²/hour, or at least 800 g/m²/hour, or at least 850 g/m²/hour, or at least 900 g/m²/hour, or at least 950 g/m²/hour, or at least 1000 g/m²/hour. In certain embodiments, the average high octane compound (e.g., alcohol such as ethanol) permeate flux may be up to 30 kg/m²/hour, or up to 25 kg/m²/hour, or up to 20 kg/m²/hour, or up to 15 kg/m²/hour, or up to 10 kg/m²/hour, or up to 5 kg/m²/hour. For example, the average ethanol permeate flux may be in the range of from 300 g/m²/hour up to 20 kg/m²/hour, or 350 g/m²/hour up to 20 kg/m²/hour, or 500 g/m²/hour up to 10 kg/m²/hour, etc. It may be desirable for the polymeric membrane to exhibit an average permeate flux of at least 320 g/m²/hour, when the separation membrane is assembled into 5 liter volume cartridge such that the cartridge will produce the desired amount of flux to meet the system requirements. The system requirements are defined by internal combustion engines that require ethanol flux. One example is a Japan Society of Automotive Engineers technical paper JSAE 20135048 titled “Research Engine System Making Effective Use of Bio-ethanol-blended Fuels.”

Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 10 psi (69 kPa) to 400 psi (2.76 MPa) (or up to and including 100 psi (690 kPa)). For example, these processing conditions would be suitable for an alcohol (e.g., ethanol) concentration in feed gasoline of from 2% to 20%.

Separation membranes of the present disclosure may be incorporated into cartridges (i.e., modules), in particular cartridges for separating alcohol a nd/or other high octane compounds from mixtures that include gasoline or other such fuels. Suitable cartridges include, for example, spiral-wound modules, plate and frame modules, tubular modules, hollow fiber modules, pleated cartridge, and the like.

FIG. 2 is an illustration of an exemplary module 120 (specifically, a spiral-wound module) that includes a support tube 122, an exemplary composite membrane 124 of the present disclosure wound onto the support tube 122. During use, a mixture of liquids to be separated (e.g., alcohol and gasoline mixture) enters the module 120 and flows along the direction of arrows 126 into the composite membrane 124. As the mixture flows past the composite membrane layers, the liquid that is less permeable in the polymeric ionomer (e.g., gasoline or other such fuels) is not absorbed by the polymeric ionomer, while the more permeable liquid (e.g., alcohol and/or aromatics) is absorbed in and passes through the polymeric ionomer and then flows out of the center of the support tube 122 along the direction of arrow 128. For example, a high concentration of alcohol (typically with a small amount of gasoline), which is separated from an alcohol/gasoline mixture, flows out of the center of the support tube 122 as vapor and/or liquid along the direction of arrow 128, and the resultant mixture with a lower concentration of alcohol than present in the mixture that enters the composite membrane flows out of the composite membrane along the direction of arrows 129.

In certain embodiments, an exemplary cartridge has a volume in the range of from 200 milliliters (mL), or 500 mL, up to and including 5.000 liters (L). In accordance with the present disclosure, the volume of the cartridge may include, in increments of 10 mL, any range between 200 mL, or 500 mL, and 5.000 L. For example, the cartridge volume may be in the range of from 210 mL up to 4.990 L, or 510 mL up to 4.990 L, or 300 mL up to 5.000 L, or 600 mL up to 5.000

L, or 1.000 L up to 3.000 L, etc. In certain embodiments, the cartridge has a volume of 1.000 L. In certain embodiments, the cartridge has a volume of 0.800 L.

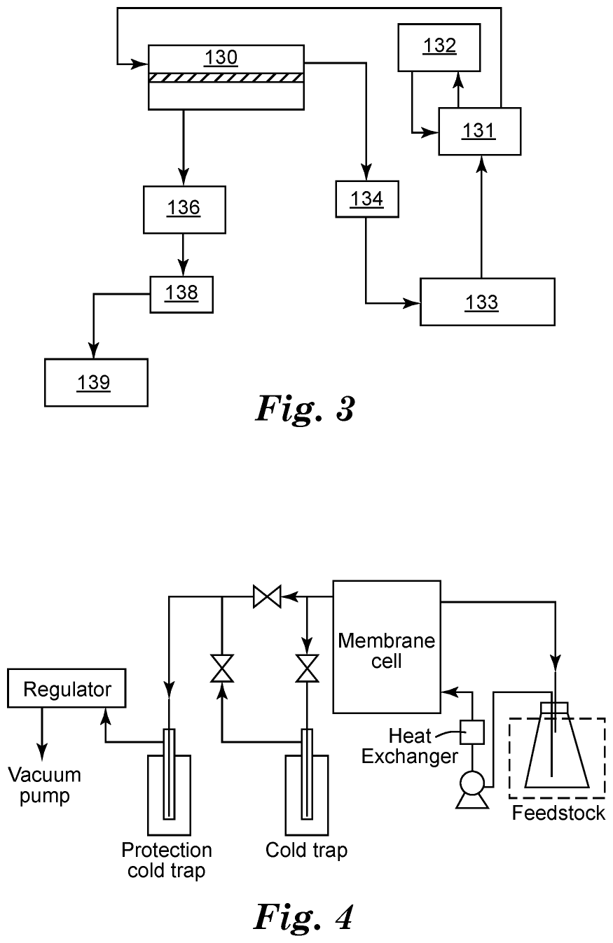

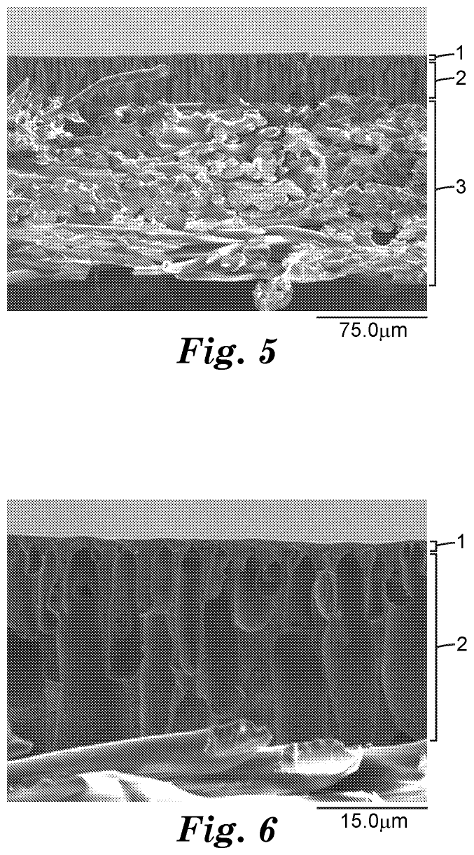

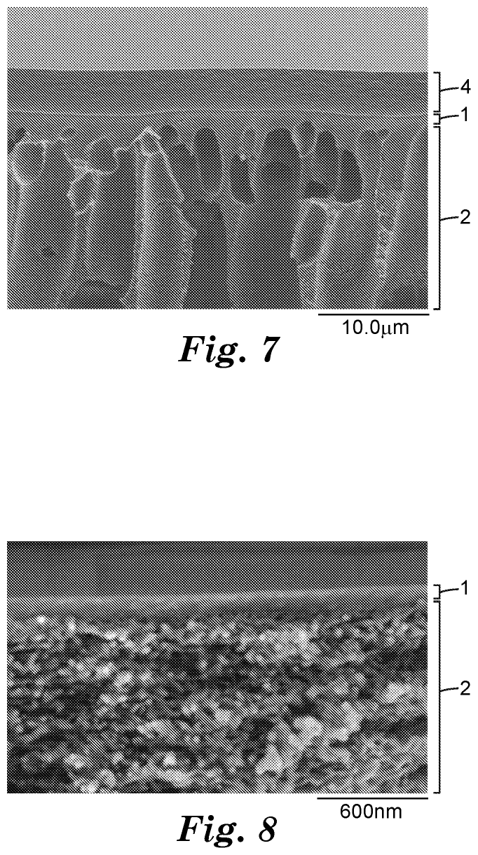

Cartridges that include separation membranes of the present disclosure may be incorporated into fuel separation systems, which may be used in, or in conjunction with, engines such as flex-fuel engines. An exemplary fuel separation system is shown in FIG. 3, which employs a membrane pervaporation method (PV method) to separate high ethanol fraction gasoline from gasoline containing ethanol. Typically, gasoline is introduced into an inlet of a membrane separation unit 130 after being passed through a heat exchanger 131 (which is connected to engine coolant 132) from a main fuel storage tank 133. A low-ethanol fraction fuel from the membrane separation unit 130 is returned to the main fuel storage tank 133 after being cooled as it passes through a radiator 134. The ethanol rich vapor which came out of membrane separation unit 130 is typically passed through a condenser 136 where it is condensed under negative pressure produced by vacuum pump 138 and then collected in an ethanol tank 139.

In certain embodiments, a fuel separation system includes one or more cartridges, which may be in series or parallel, which include separation membranes of the present disclosure.

### Exemplary Embodiments

Embodiment 1 is a method of selectively separating (e.g., pervaporating) a first fluid (e.g., first liquid) from a feed mixture comprising the first fluid (e.g., first liquid) and a second fluid (e.g., second liquid), the method comprising contacting the feed mixture with a separation membrane comprising a polymeric ionomer, wherein the polymeric ionomer has a highly fluorinated backbone and recurring pendant groups according to the following formula (Formula I):

—O—R_{f}—[—SO₂—N⁻(Z⁺)—SO₂—R—]ₘ—[SO₂]ₙ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4;
   m=0 to 6; and
   n=0 or 1;
   with the proviso that at least one of m or n must be non-zero;

wherein the polymeric ionomer is more permeable to the first fluid (e.g., first liquid) than the second fluid (e.g., second liquid);

with the proviso that when m =0 and Q is -0⁻Y⁺, the first fluid (e.g., first liquid) is alcohol and the second fluid (e.g., second liquid) is gasoline. Embodiment 2 is a separation membrane for selectively pervaporating a first liquid from a feed mixture comprising the first liquid and a second liquid, the separation membrane comprising:

a polymeric ionomer in the form of a layer having a thickness, with the polymeric ionomer having a highly fluorinated backbone and recurring pendant groups according to the following formula (Formula I):

—O—R_{f}—[—SO₂—N⁻(Z⁺)—SO₂—R—]ₘ—[SO₂]ₙ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4;
   m=0 to 6; and
   n=0 or 1;
   with the proviso that at least one of m or n must be non-zero;

wherein the polymeric ionomer is more permeable to the first liquid than the second liquid, Q is not —O⁻Y⁺ when m=0, and m is not 0 when Q is —O⁻Y⁺.

Embodiment 3 is a combination of a gasoline fuel system and a separation membrane for selectively pervaporating a first liquid from a feed mixture comprising the first liquid and a second liquid, with the first liquid being a high octane compound, the second liquid being gasoline, and the separation membrane comprising:

a polymeric ionomer in the form of a layer having a thickness,

wherein the polymeric ionomer is more permeable to the high octane compound than the gasoline and has a highly fluorinated backbone and recurring pendant groups according to the following formula (Formula I):

—O—R_{f}—[—SO₂—N⁻(Z⁺)—SO₂—R—]ₘ—[SO₂]ₙ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4;
   m=0 to 6; and
   n=0 or 1;
   with the proviso that at least one of m or n must be non-zero.

Embodiment 4 is the method according to embodiment 1, the separation module according to embodiment 2, or the combination according to embodiment 3, wherein the separation membrane is in a cartridge.

Embodiment 5 is the method according to embodiment 1, the separation module according to embodiment 2, the combination according to embodiment 3, or the cartridge according to embodiment 4, wherein the separation membrane is a free-standing membrane.

Embodiment 6 is the method according to embodiment 1, the separation module according to embodiment 2, the combination according to embodiment 3, or the cartridge according to embodiment 4, wherein the separation membrane further comprises a substrate on which the polymeric ionomer is disposed.

Embodiment 7 is the method, separation membrane, combination, or cartridge according to embodiment 6, wherein the substrate is a porous substrate comprising opposite first and second major surfaces, and a plurality of pores, and the layer of the polymeric ionomer is on a major surface of the porous substrate and optionally in the pores.

Embodiment 8 is the method, separation membrane, combination, or cartridge according to embodiment 7, wherein the porous substrate is a polymeric porous substrate.

Embodiment 9 is the method, separation membrane, combination, or cartridge according to embodiment 7, wherein the porous substrate a ceramic porous substrate.

Embodiment 10 is the method, separation membrane, combination, or cartridge according to any one of embodiments 7 through 9, wherein the porous substrate is asymmetric or symmetric.

Embodiment 11 is the method, separation membrane, combination, or cartridge according to any one of embodiments 7 through 10, wherein the porous substrate comprises a nanoporous layer.

Embodiment 12 is the method, separation membrane, combination, or cartridge according to embodiment 11, wherein the nanoporous layer is adjacent to or defines the first major surface of the porous substrate.

Embodiment 13 is the method, separation membrane, combination, or cartridge according to any one of embodiments 7 through 12, wherein the porous substrate comprises a microporous layer.

Embodiment 14 is the method, separation membrane, combination, or cartridge according to embodiment 13, wherein the microporous layer is adjacent to or defines the second major surface of the porous substrate.

Embodiment 15 is the method, separation membrane, combination, or cartridge according to any one of embodiments 7 through 14, wherein the porous substrate comprises a macroporous layer.

Embodiment 16 is the method, separation membrane, combination, or cartridge according to embodiment 15, wherein the macroporous layer is adjacent to or defines the second major surface of the porous substrate.

Embodiment 17 is the method, separation membrane, combination, or cartridge according to any one of embodiments 7 through 16, wherein the porous substrate has a thickness measured from one to the other of the opposite major surfaces in the range of from 5 μm up to and including 500 μm.

Embodiment 18 is the method, separation membrane, combination, or cartridge according to embodiment 11 or 12, wherein the nanoporous layer has a thickness in the range of from 0.01 μm up to and including 10 μm.

Embodiment 19 is the method, separation membrane, combination, or cartridge according to embodiment 13 or 14, wherein the microporous layer has a thickness in the range of from 5 μm up to and including 300 μm.

Embodiment 20 is the method, separation membrane, combination, or cartridge according to embodiment 15 or 16, wherein the macroporous layer has a thickness in the range of from 25 μm up to and including 500 μm.

Embodiment 21 is the method, separation membrane, combination, or cartridge according to any one of embodiments 7 through 20, wherein the porous substrate comprises pores having an average size in the range of from 0.5 nanometer (nm) up to and including 1000 μm.

Embodiment 22 is the method, separation membrane, combination, or cartridge according to any one of embodiments 11, 12, and 18, wherein the nanoporous layer comprises pores having a size in the range of from 0.5 nanometer (nm) up to and including 100 nm.

Embodiment 23 is the method, separation membrane, combination, or cartridge according to any one of embodiments 13, 14, and 19, wherein the microporous layer comprises pores having a size in the range of from 0.01 μm up to and including 20 μm.

Embodiment 24 is the method, separation membrane, combination, or cartridge according to any one of embodiments 15, 16, and 20, wherein the macroporous layer comprises pores having a size in the range of from 1 μm up to and including 1000 μm.

Embodiment 25 is the method, separation membrane, combination, or cartridge according to any one of embodiments 7 through 24, wherein the polymeric ionomer forms a polymer layer on the first major surface of the porous substrate wherein a majority of the polymer composition is on the surface of the porous substrate.

Embodiment 26 is the method, separation membrane, combination, or cartridge according to embodiments 7 through 25, wherein the polymeric ionomer is disposed in at least some of the pores so as to form a layer having a thickness within the porous substrate.

Embodiment 27 is the method, separation membrane, combination, or cartridge according to embodiment 26, wherein the polymeric ionomer is in the form of a pore-filling polymer layer that forms at least a portion of the first major surface of the porous substrate.

Embodiment 28 is the method, separation membrane, combination, or cartridge according to any one of embodiments 7 through 27, which is asymmetric or symmetric with respect to the amount of polymeric ionomer.

Embodiment 29 is the method, separation membrane, combination, or cartridge according to embodiment 28, wherein the amount of the polymeric ionomer at, on, or adjacent to the first major surface of the porous substrate is greater than the amount of the polymeric ionomer at, on, or adjacent to the second major surface of the porous substrate.

Embodiment 30 is the method, separation membrane, combination, or cartridge according to any one of embodiments 27 through 29, wherein the polymeric ionomer is in the form of a pore-filling polymer layer having an exposed major surface, which coats the first major surface of the porous substrate, and an opposite major surface disposed between the opposite first and second major surfaces of the porous substrate.

Embodiment 31 is the method, separation membrane, combination, or cartridge according to embodiment 30, wherein the exposed major surface of the pore-filling polymer layer coats all the first major surface of the porous substrate.

Embodiment 32 is the method, separation membrane, combination, or cartridge according to any one of embodiments 5 through 31, wherein the polymer layer has a thickness in the range of from 10 nm up to and including 50 microns (50,000 nm).

Embodiment 33 is the method, separation membrane, combination, or cartridge according to any one of embodiments 1 through 32, wherein the first fluid (e.g., first liquid) is an alcohol and/or other high octane compounds such as aromatic hydrocarbons.

Embodiment 34 is the method, separation membrane, combination, or cartridge according to any one of embodiments 1 through 33, wherein the second fluid (e.g., second liquid) is gasoline.

Embodiment 35 is the method, separation membrane, combination, or cartridge according to embodiment 34, wherein the first fluid (e.g., first liquid) is an alcohol, and the second fluid (e.g., second liquid) is gasoline.

Embodiment 36 is the method, separation membrane, combination, or cartridge according to any one of embodiments 5 through 35, wherein the polymer layer forms a continuous layer.

Embodiment 37 is the method, separation membrane, combination, or cartridge according to any one of embodiments 1 through 36, wherein the polymeric ionomer has a highly fluorinated backbone and recurring pendant groups according to the following formula (Formula II):

—O—R_{f}—[—SO₂—]-Q
wherein:
   R_{f} is a perfluorinated organic linking group;
   Q is —NH₂ or —O⁻Y⁺; and
   Y⁺ is H⁺, a monovalent cation, or a multivalent cation;

with the proviso that when Q is —O⁻Y⁺, the first fluid (e.g., first liquid) is alcohol and the second fluid (e.g., second liquid) is gasoline.

Embodiment 38 is the method, separation membrane, combination, or cartridge according to any one of embodiments 1 through 36, wherein the polymeric ionomer has a highly fluorinated backbone and recurring pendant groups according to the following formula (Formula III):

—O—R_{f}—[—SO₂—N⁻(Z⁺)—SO₂—R—]ₘ-Q
wherein:
   R_{f} is a perfluorinated organic linking group;
   R is an organic linking group;
   Z⁺ is H⁺, a monovalent cation, or a multivalent cation;
   Q is H, F, —NH₂, —O⁻Y⁺, or —CₓF₂ₓ₊₁;
   Y⁺ is H⁺, a monovalent cation, or a multivalent cation;
   x=1 to 4; and
   m=0 to 6;

Embodiment 39 is the method, separation membrane, combination, or cartridge according to any one of embodiments 1 through 38, wherein the polymeric ionomer exhibits a high octane (e.g., an alcohol) selectivity in the range of from at least 30% up to and including 100%.

Embodiment 40 is the method, separation membrane, combination, or cartridge according to any one of embodiments 1 through 39, wherein the polymeric ionomer exhibits an average alcohol permeate (e.g., alcohol from an alcohol/gasoline mixture) flux in the range of from at least 300 g/m²/hour up to and including 30 kg/m²/hour, using a feed temperature in the range of from at least −20° C. up to and including 120° C., a permeate vacuum pressure in the range of from 20 Torr (2.67 kPa) to and including 760 Torr (101 kPa), a feed pressure in the range of at least 10 psi (69 kPa) up to and including 400 psi (2.76 MPa), and an alcohol concentration in feed gasoline/alcohol mixture in the range of from at least 2% up to and including 20%.

Embodiment 41 is the method, separation membrane, combination, or cartridge according to any one of embodiments 1 through 40, further comprising a (meth)acryl-containing polymer (i.e., (meth)acrylate polymer).

Embodiment 42 is the method, separation membrane, combination, or cartridge according to embodiment 41, wherein the (meth)acryl-containing polymer is derived from one or more (meth)acryl-containing monomers and/or oligomers selected from the group of a polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, 2-acrylamido-2-methylpropanesulfonic acid (AMPS), and combinations of such monomers and/or oligomers.

Embodiment 43 is the method, separation membrane, combination, or cartridge according to embodiment 41 or 42, wherein the (meth)acrylate polymer is mixed with the polymeric ionomer.

Embodiment 44 is the method, separation membrane, combination, or cartridge according to embodiment 41 or 42, wherein the (meth)acrylate polymer and polymeric ionomer are in separate layers.

Embodiment 45 is the method, separation membrane, combination, or cartridge according to any one of embodiments 1 through 44, further comprising an epoxy polymer.

Embodiment 46 is the method, separation membrane, combination, or cartridge according to embodiment 45, wherein the epoxy polymer is mixed with the polymeric ionomer or wherein the epoxy polymer and polymeric ionomer are in separate layers.

Embodiment 47 is the method, separation membrane, combination, or cartridge according to any one of embodiments 1 through 46, further comprising at least one of:
(a) an ionic liquid mixed with the polymeric ionomer; or
(b) an amorphous fluorochemical film disposed on the separation membrane.

Embodiment 48 is the method, separation membrane, combination, or cartridge according to claim 47, wherein the amorphous fluorochemical film is a plasma-deposited fluorochemical film.

Embodiment 49 is the method, separation membrane, combination, or cartridge according to claim 47, wherein the amorphous fluorochemical film comprises an amorphous glassy perfluoropolymer having a Tg of at least 100° C.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

For all polymeric ionomer coated on a porous substrate in the following examples, the polymeric ionomer is applied to the nanoporous side of the substrate.

### Materials

Ethanol, DLI Inc., King of Prussia, PA
Hexane, EMD Chemicals, Inc.
E10 gasoline, blend gasoline with 10% ethanol
3M PFSA 825EW, prepared according to the example described in U.S. Pat. No. 7,348,088, where the ratio of tetrafluoroethylene (TFE) and F-SO₂—CF₂CF₂CF₂CF₂—O—CF═CF₂ (Comonomer A) was chosen to result in an equivalent weight of 825 g/mol.
3M PFSA 725EW, prepared according to the example described in U.S. Pat. No. 7,348,088, where the ratio of tetrafluoroethylene (TFE) and F—SO₂—CF₂CF₂CF₂CF₂—O—CF═CF₂ (Comonomer A) was chosen to result in an equivalent weight of 725 g/mol.
3M PFSA 1000 EW, prepared according to the example described in U.S. Pat. No. 7,348,088, where the ratio of tetrafluoroethylene (TFE) and F—SO₂—CF₂CF₂CF₂CF₂—O—CF═CF₂ (Comonomer A) was chosen to result in an equivalent weight of 1000 g/mol.
3M PFIA, prepared according to U.S. Pat. Pub. No. 2013/0029249A1, Example 3
KAPTON polyimide film, DuPont, Wilmington, Del.
Lithium chloride, Alfa Aesar, Ward Hill, Mass.
PA350, polyacrylonitrile substrate, Nanostone Water, formerly known as Sepro Membranes Inc., Oceanside, Calif., used as received
PE2, polyethersulfone substrate, obtained from Nanostone Water, formerly known as Sepro Membranes Inc., Oceanside, Calif., used as received
PE5, polyethersulfone substrate, obtained from Nanostone Water, formerly known as Sepro Membranes Inc., Oceanside, Calif., used as received
NaCl, EM Science, Gibbstown, N.J.
KCl, Aldrich, Milwaukee, Wis.
CH₃CO₂Cs, Cesium acetate, Aldrich, Milwaukee, Wis.,
ZnCl₂, Alfa Aesar, Ward Hill, Mass.
FeSO₄.H₂O, J T Baker, Phillipsburg, N.J.
AlCl₃, EM Science, Gibbstown, N.J.
NAFION 2020, Sigma Aldrich, Milwaukee, Wis.
SR344, polyethyleneglycol 400 diacrylate, Sartomer Company, Exton, Pa.
SR610, polyethyleneglycol 600 diacrylate, Sartomer Company, Exton, Pa.
SR603, polyethyleneglycol 400 dimethacrylate, Sartomer Company, Exton, Pa.
EX512, polyglycerol polyglycidyl ether, Nagase Chemtex Corporation, Japan
EX521, polyglycerol polyglycidyl ether, Nagase Chemtex Corporation, Japan
JEFFAMINE D400, Huntsman Corporation, The Woodlands, Tex.
TEFLON AF2400, DuPont Company, Wilmington, Del.
HFE-7200, NOVEC solvent, 3M Company, St Paul, Minn.
DP760, epoxy adhesive, 3M Company, St Paul MN
HMIM-B(CN)₄, 1-Hexyl-3-methylimidazolium tetracyanoborate, Merck KGaA, Damstadt, Germany
EMIM-TFSA, 1-ethyl-3-methylimidazolium trifluoromethanesulfonate, Sigma Aldrich, Milwaukee, Wis.
EMIM-BF₄, 1-ethyl-3-methylimidazolium tetrafluoroborate, Sigma Aldrich, Milwaukee, Wis.
EMIM-Tf₂N, 1-ethyl-3-methylimidazolium bis(trifluoromethylsulfonyl)imide, Sigma Aldrich, Milwaukee, Wis.
C₆F₁₄, PF-5060, perfluorohexane, 3M Company, St Paul, Minn.
C₃F₈, PFG-3218, perfluoropropane, 3M Company, St Paul, Minn.
O₂, Ultrahigh purity oxygen (99.999%), Oxygen Service Company, St Paul, Minn.
Polyacrylic acid, 50% aqueous solution, MW 5000, Alfa Aesar, Ward Hill, Mass.
PHOTO1173, 2-hydroxy-2-methylpropiophenone, TCI-EP, Tokyo Kogyo Co. Ltd, Tokyo, Japan
Toluene, UN1294, BDH, VWR International LLC, Radnor, Pa.
o-Xylene, Alfa Aesar, Ward Hill, Mass.
Isooctane, 2,2,4-trimethylpentane, Alfa Aesar, Ward Hill, Mass.
1,2,4-Trimethylbenzene, Alfa Aesar, Ward Hill, Mass.
Heptane, UN1206, BDH, VWR International LLC, Radnor, Pa.

### Methods

### Method 1

The ability of the membranes to separate ethanol from an ethanol/gasoline mixture was determined using the test apparatus depicted in FIG. 4 and the following technique. The membrane sample was mounted onto a stainless steel cell (SEPA CF II, obtained from General Electric Co., Fairfield, Conn.). The effective membrane surface area was 140 cm². A feedstock of E10 gasoline (10% ethanol) was heated by a heat exchanger and pumped through the membrane cell at a flow rate of 500 ml/min. The input and output temperatures of the feedstock at the inlet and outlet of the membrane cell was monitored by thermocouples. The permeate was collected in a cold trap cooled with liquid nitrogen. The membrane cell vacuum was controlled by a regulator connected to a vacuum pump. Testing was performed under conditions: 70° C. feedstock temperature and 200 Torr (26.7 kPa) vacuum. The total permeate mass flux was calculated as:

$$Flux = \frac{m}{A \times t}$$

where m is the mass of the permeate in kilograms (kg); A is the effective membrane area in square meters (m²); and t is the permeate collection duration time in hours (h). The ethanol content of the permeate and the feedstock were measured by gas chromatography (GC) using an Agilent Model 7890C gas chromatograph. The alcohol content was determined by using a calibration line, obtained by running known concentrations of ethanol through the GC and measuring the GC response area. Then the response area measurements of the permeate and feedstock from the GC were obtained and then using the calibration line the % ethanol was determined. Ethanol mass flux was calculated as membrane mass flux multiplied by the ethanol concentration in the permeate.

The permeate was collected each 10 min for one measurement and five measurements were taken for each membrane testing. The average data of the last three measurements were used to represent the membrane performance.

### Method 2

The ability of the membranes to separate ethanol from an ethanol/gasoline mixture was determined as Method 1 above except the test apparatus was run in a continuous mode after charging the initial test vessel with about 1.1 liters of gasoline. Testing was conducted for 120 min. The flow rate of the feed stream was maintained at 500 mL/min. Vacuum in the membrane permeate side was set at 200 Torr (26.7 kPa) and the average gasoline temperature at the inlet and outlet of the membrane cell was maintained at 70° C. Permeate samples were collected every 10 minutes and the feed ethanol contents were monitored every 10 min. The fuel ethanol depletion curve was drawn as a function of the testing time. The time to reach 2 wt-% was obtained by extending the trend line of the ethanol depletion curve. The average ethanol flux was calculated as follows

flux=m(c₀−2%)/t/A

Where m, the initial charged mass of feed gasoline, c₀ is the initial ethanol content; t is the time for feed ethanol reaching 2 wt-%, and A is the active membrane area of the testing cell. The average permeate ethanol was calculated from all of the permeate collected and their ethanol contents.

### Method 3

One 76 mm disk of a membrane sample was cut and mounted in a solvent resistant stirred cell (obtained from EMD-Millipore Company). About 100 gram a solvent mixture containing approximately 10 weight percent mixture of ethanol (DLI Inc., King of Prussia, Pa.) in hexane (EMD Chemicals, Inc) was charged into the cell. The ethanol and hexane mixture was kept at room temperature and pressure and a vacuum of about 15 millimeters of mercury (2.0 kPa) was applied to the permeate side. The permeate vapor was condensed using a liquid nitrogen trap. Samples were run for 60 minutes and the ethanol content in the starting mixture, final mixture, and permeate was measured using a GC as in Method 1.

### Method 4

An ethanol separation in a stirred cell was conducted in a stirred cell as in Method 3 except the feedstock was heated up to up to 70° C. by one infrared lamp. The cell was pressured to 300 kPa by nitrogen to avoid gasoline boiling. 216 Torr (28.8 kPa) vacuum was applied in the permeate side by a diaphragm vacuum pump. Each membrane sample was tested for 45 minutes. Ethanol flux was calculated from the ethanol contents in the starting feedstock mixture, the final mixture, and the collected permeate was measured using a GC in Method 3.

### Method 5

The membrane sample was soaked into a chamber of an autoclave with the temperature setting of 80° C. After 140 hours exposure time, the pressure was released and the sample was removed and dried out at ambient conditions. The performance of the hot gasoline exposed membrane was evaluated as in Method 1.

### Method 6

The ability of the membranes to separate both aromatics and ethanol was determined as Method 1 except that one model fuel was used for measurement. The model fuel was formulated by mixing 60 vol % heptane, 10 vol % toluene, 10 vol % o-xylene, 10 vol % 1,2,4-trimethylbenzene and l0 vol % ethanol. The content of each component in the permeate was analyzed by GC. The total aromatic selectivity was calculated by the total aromatic content (toluene (T), o-xylene (X) and 1,2,4-trimethylbenzene (mB)) in the permeate excluding ethanol.

$$Aromatic selectivity = \frac{{c}_{T} + {c}_{X} + {c}_{mB}}{100 \% - {c}_{EtOH}}$$

Where c_{T} is toluene content in the permeate, c_{X} is o-xylene content in the permeate, c_{mB} is 1,2,4-trimethylbenzene content in the permeate, and C_{EtOH} is ethanol content in the permeate.

### EXAMPLES

### Examples 1-6; Ionomer Only, No Support

Films of 3M PFSA 825EW ionomer were fabricated by casting a 20 weight percent solids dispersion in ethanol (75 weight percent) and water (25 weight percent) onto a DuPONT KAPTON polyimide film on a Hirano coating line using a slot die. The solvent was evaporated in four temperature controlled ovens set to 80°, 100°, 140° and 140° C. with the line moving at 2 meters per minute. The dry film was then further annealed at 200° C. by contacting with a heated roll for 3 minutes. The resulting films were then removed from the KAPTON liner and placed in a 1 molar solution of lithium chloride for ion exchange. The film was triple rinsed in deionized water and allowed to dry at room temperature. These films were evaluated for flux and selectivity using a stirred cell in Method 3 and the results are shown in Table 1.

TABLE 1

| | | | | | | | Ethanol | |
|---|---|---|---|---|---|---|---|---|
| | | | Ionomer | Coun- | | Selec- | Flux | Final |
| | Re- | | thickness | ter | Sup- | tivity | (Kg/ | Conc. |
| Ex | peats | Ionomer | (μm) | Ion | port | (%) | m²/hr) | (%) |
| 1 | 3 | 825 EW | 5 | Li+ | None | 91% | 2.14 | 3.1% |
| 2 | 2 | 825 EW | 10 | Li+ | None | 96% | 1.87 | 3.7% |
| 3 | 2 | 825 EW | 15 | Li+ | None | 100% | 1.61 | 4.4% |
| 4 | 4 | 825 EW | 20 | Li+ | None | 98% | 1.30 | 5.1% |
| 5 | 2 | 825 EW | 30 | Li+ | None | 99% | 0.93 | 5.8% |
| 6 | 1 | 825 EW | 50 | Li+ | None | 99% | 0.75 | 2.6% |

### Example 7; 725 EW Ionomer on Nanoporous Substrate H+ Form

A 2 micrometer layer of 3M PFSA 725 EW ionomer was coated onto a PA350 (polyacrylonitrile) nanoporous substrate by coating a 12.5 weight percent solids dispersion in ethanol (75 weight percent) and water (25 weight percent) in a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 2).

### Example 8; 725 EW Ionomer on Nanoporous Substrate Li+ Form

The membrane described in Example 7 was ion exchanged by soaking in 1M (molar/liter) LiCl for 30 minutes followed by rinsing in deionized water and then allowed to try at room temperature overnight. The sample was tested in Method 1 for selectivity and flux (Table 2).

### Example 9; 725 EW Ionomer on Nanoporous Substrate Na+ Form

The membrane described in Example 7 was ion exchanged by soaking in 1M NaCl for 30 minutes followed by rinsing in deionized water and then allowed to try at room temperature overnight. The sample was tested in Method 1 for selectivity and flux (Table 2).

### Example 10; 725 EW Ionomer on Nanoporous Substrate K+ Form

The membrane described in Example 7 was ion exchanged by soaking in 1M KCl for 30 minutes followed by rinsing in deionized water and then allowed to try at room temperature overnight. The sample was tested in Method 1 for selectivity and flux (Table 2).

### Example 11; 725 EW Ionomer on Nanoporous Substrate Cs+ Form

The membrane described in Example 7 was ion exchanged by soaking in 0.25M CsCH₃CO₂ for 30 minutes followed by rinsing in deionized water and then allowed to try at room temperature overnight. The sample was tested in Method lfor selectivity and flux (Table 2).

TABLE 2

| | | Ionomer | | | | Ethanol |
|---|---|---|---|---|---|---|
| | | thickness | Counter | | Selectivity | Flux |
| Example | Ionomer | (μm) | Ion | Support | (%) | (Kg/m²/hr) |
| 7 | 725 EW | 2 | H+ | PA350 | 85.1% | 2.43 |
| 8 | 725 EW | 2 | Li+ | PA350 | 74.5% | 2.65 |
| 9 | 725 EW | 2 | Na+ | PA350 | 93.9% | 1.41 |
| 10 | 725 EW | 2 | K+ | PA350 | 42.9% | 0.41 |
| 11 | 725 EW | 2 | Cs+ | PA350 | 61.2% | 0.46 |

### Example 12; 825 EW Ionomer on Nanoporous Substrate H+ Form

A 2 micrometer layer of 3M PFSA 825 EW ionomer was coated onto a PA350 nanoporous substrate by coating a 12.5 weight percent solids dispersion in ethanol (75 weight percent) and water (25 weight percent) using a Hirano (four oven) coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 3).

### Example 13; 825 EW Ionomer on Nanoporous Substrate Li+ Form

The membrane described in Example 12 was ion exchanged by soaking in 1M LiCl for 30 minutes followed by rinsing in deionized water and then allowed to try at room temperature overnight. The sample was tested in Method 1 for selectivity and flux (Table 3).

### Example 14; 825 EW Ionomer on Nanoporous Substrate Na+ Form

The membrane described in Example 12 was ion exchanged by soaking in 1M NaCl for 30 minutes followed by rinsing in deionized water and then allowed to try at room temperature overnight. The sample was tested in Method 1 for selectivity and flux (Table 3).

### Example 15; 825 EW Ionomer on Nanoporous Substrate K+ Form

The membrane described in Example 12 was ion exchanged by soaking in 1M KCl for 30 minutes followed by rinsing in deionized water and then allowed to try at room temperature overnight. The sample was tested in Method 1 for selectivity and flux (Table 3).

### Example 16; 825 EW Ionomer on Nanoporous Substrate Cs+ Form

The membrane described in Example 12 was ion exchanged by soaking in 0.25M CH₃CO₂Cs for 30 minutes followed by rinsing in deionized water and then allowed to try at room temperature overnight. The sample was tested in Method 1 for selectivity and flux (Table 3).

### Example 17; 825 EW Ionomer on Nanoporous Substrate Zn+2 Form

The membrane described in Example 12 was ion exchanged by soaking in 0.5M ZnCl₂ for 30 minutes followed by rinsing in deionized water and then allowed to try at room temperature overnight. The sample was tested in Method 1 for selectivity and flux (Table 3).

### Example 18; 825 EW Ionomer on Nanoporous Substrate Fe+2 Form

The membrane described in Example 12 was ion exchanged by soaking in 0.25M FeSO₄H₂O for 30 minutes followed by rinsing in deionized water and then allowed to try at room temperature overnight. The sample was tested in Method 1 for selectivity and flux (Table 3).

### Example 19; 825 EW Ionomer on Nanoporous Substrate Al+3 Form

The membrane described in Example 12 was ion exchanged by soaking in 0.25M AlCl₃ for 30 minutes followed by rinsing in deionized water and then allowed to try at room temperature overnight. The sample was tested in Method 1 for selectivity and flux (Table 3).

TABLE 3

| | | Ionomer | | | | Ethanol |
|---|---|---|---|---|---|---|
| | | thickness | Counter | | Selectivity | Flux |
| Example | Ionomer | (μm) | Ion | Support | (%) | (Kg/m²/hr) |
| 12 | 825 EW | 2 | H⁺ | PA350 | 92.2% | 1.84 |
| 13 | 825 EW | 2 | Li⁺ | PA350 | 69.1% | 3.25 |
| 14 | 825 EW | 2 | Na⁺ | PA350 | 96.8% | 1.56 |
| 15 | 825 EW | 2 | K⁺ | PA350 | 91.6% | 0.59 |
| 16 | 825 EW | 2 | Cs⁺ | PA350 | 66.6% | 0.57 |
| 17 | 825 EW | 2 | Zn⁺² | PA350 | 93.6% | 2.68 |
| 18 | 825 EW | 2 | Fe⁺² | PA350 | 91.4% | 1.96 |
| 19 | 825 EW | 2 | Al⁺³ | PA350 | 97.5% | 2.09 |

### Example 20; 1000 EW Ionomer on Nanoporous Substrate H⁺ Form

A 2 micrometer layer of 3M PFSA1000 EW ionomer was coated onto a PA350 nanoporous substrate by casting a 12.5 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 4).

### Example 21; 1000 EW Ionomer on Nanoporous Substrate Li⁺ Form

The membrane described in Example 12 was ion exchanged by soaking in 1M LiCl for 30 minutes followed by rinsing in deionized water and then allowed to try at room temperature overnight. The sample was tested in Method 1 for selectivity and flux (Table 4).

### Example 22; 1000 EW Ionomer on Nanoporous Substrate Na⁺ Form

The membrane described in Example 12 was ion exchanged by soaking in 1M NaCl for 30 minutes followed by rinsing in deionized water and then allowed to try at room temperature overnight. The sample was tested in Method 1 for selectivity and flux (Table 4).

### Example 23; 1000 EW Ionomer on Nanoporous Substrate K⁺ Form

The membrane described in Example 12 was ion exchanged by soaking in 1M KCl for 30 minutes followed by rinsing in deionized water and then allowed to try at room temperature overnight. The sample was tested in Method 1 for selectivity and flux (Table 4).

### Example 24; 1000 EW Ionomer on Nanoporous Substrate Cs⁺ Form

The membrane described in Example 12 was ion exchanged by soaking in 0.25M CH₃CO₂Cs for 30 minutes followed by rinsing in deionized water and then allowed to try at room temperature overnight. The sample was tested in Method 1 for selectivity and flux (Table 4).

TABLE 4

| | | Ionomer | | | Selec- | Ethanol |
|---|---|---|---|---|---|---|
| | | thickness | Counter | | tivity | Flux |
| Example | Ionomer | (μm) | Ion | Support | (%) | (Kg/m²/hr) |
| 20 | 1000 EW | 2 | H⁺ | PA350 | 73.2% | 1.88 |
| 21 | 1000 EW | 2 | Li⁺ | PA350 | 71.1% | 3.25 |
| 22 | 1000 EW | 2 | Na⁺ | PA350 | 96.3% | 1.45 |
| 23 | 1000 EW | 2 | K⁺ | PA350 | 19.8% | 0.61 |
| 24 | 1000 EW | 2 | Cs⁺ | PA350 | 53.9% | 0.69 |

### Example 25; PFIA Ionomer on Nanoporous Substrate H+ Form

A 2 micrometer layer of 3M PFIA ionomer was coated onto a PA350 nanoporous substrate by casting a 12.5 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 5).

### Example 26; PFIA Ionomer on Nanoporous Substrate Li⁺ Form

The membrane described in Example 12 was ion exchanged by soaking in 1M LiCl for 30 minutes followed by rinsing in deionized water and then allowed to try at room temperature overnight. The sample was tested in Method 1 for selectivity and flux (Table 5).

### Example 27; PFIA Ionomer on Nanoporous Substrate Na⁺ Form

The membrane described in Example 12 was ion exchanged by soaking in 1M NaCl for 30 minutes followed by rinsing in deionized water and then allowed to try at room temperature overnight. The sample was tested in Method 1 for selectivity and flux (Table 5).

### Example 28; PFIA Ionomer on Nanoporous Substrate K⁺ Form

The membrane described in Example 12 was ion exchanged by soaking in 1M KCl for 30 minutes followed by rinsing in deionized water and then allowed to try at room temperature overnight. The sample was tested in Method 1 for selectivity and flux (Table 5).

### Example 29; PFIA EW Ionomer on Nanoporous Substrate Cs⁺ Form

The membrane described in Example 12 was ion exchanged by soaking in 0.25M CH₃CO₂Cs for 30 minutes followed by rinsing in deionized water and then allowed to try at room temperature overnight. The sample was tested in Method 1 for selectivity and flux (Table 5).

TABLE 5

| | | Ionomer | | | | Ethanol |
|---|---|---|---|---|---|---|
| | | thickness | Counter | | Selectivity | Flux |
| Example | Ionomer | (μm) | Ion | Support | (%) | (Kg/m²/hr) |
| 25 | 620 EW | 2 | H⁺ | PA350 | 70.4% | 3.41 |
| | PFIA | | | | | |
| 26 | 620 EW | 2 | Li⁺ | PA350 | 46.7% | 3.40 |
| | PFIA | | | | | |
| 27 | 620 EW | 2 | Na⁺ | PA350 | 93.7% | 2.01 |
| | PFIA | | | | | |
| 28 | 620 EW | 2 | K⁺ | PA350 | 30.2% | 0.93 |
| | PFIA | | | | | |
| 29 | 620 EW | 2 | Cs⁺ | PA350 | 14.8% | 0.85 |
| | PFIA | | | | | |

### Example 30; Perfluoro Amide (PFA) Ionomer on Nanoporous Substrate H⁺ Form

A 2 micrometer layer of 3M perfluoro-sulfonamide ionomer (Formula II, where R_{f}=C₄F₈ and Q=NH₂, prepared according to U.S. Pat. Pub. No. 2013/0029249A1, Example 1) was coated onto a PA350 nanoporous substrate by casting a 10 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 6).

### Example 31; Perfluoro Phenyl Imide (PFPI) Ionomer on Nanoporous Substrate H+ Form

A 2 micrometer layer of perfluoro phenyl imide ionomer ionomer (Formula III, where R_{f}=C₄F₈, R=benzyl, and Q=H, prepared according to U.S. Pat. Pub. No. 2013/0029249A1 synthesized following Example 2 by substituting benzylsulfonyl chloride for 4-bromobenzylsulfonyl chloride) was coated onto a PA350 nanoporous substrate by casting a 10 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 6).

TABLE 6

| | | Ionomer | | | Selec- | Ethanol |
|---|---|---|---|---|---|---|
| | | thickness | Counter | | tivity | Flux |
| Example | Ionomer | (μm) | Ion | Support | (%) | (Kg/m²/hr) |
| 30 | PFA | 2 | H⁺ | PA350 | 71.4% | 2.55 |
| 31 | PFPI | 2 | H⁺ | PA350 | 66.0% | 2.82 |

### Example 32; 825 EW Ionomer on Nanoporous Substrate 0.5 Micrometer

A 0.5 micrometer layer of 3M PFSA 825 EW ionomer was coated onto a PA350 nanoporous substrate by casting a 10 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The membrane was ion exchanged by soaking in 1M LiCl for 30 minutes followed by rinsing in deionized water and then allowed to try at room temperature overnight. The sample was tested in Method 1 for selectivity and flux (Table 7).

### Example 33; 825 EW Ionomer on Nanoporous Substrate 1.0 Micrometer

A 1.0 micrometer layer of 3M PFSA 825EW was coated and ion exchanged as described in Example 32. The sample was tested in Method 1 for selectivity and flux (Table 7).

### Example 34; 825 EW Ionomer on Nanoporous Substrate 1.5 Micron

A 1.5 micrometer layer of 3M PFSA 825EW was coated and ion exchanged as described in Example 32. The sample was tested in Method 1 for selectivity and flux (Table 7).

### Example 35; 825 EW Ionomer on Nanoporous Substrate 2.0 Micrometers

A 2.0 micrometer layer of 3M PFSA 825EW was coated and ion exchanged as described in Example 32. The sample was tested in Method 1 for selectivity and flux (Table 7).

### Example 36; 825 EW Ionomer on Nanoporous Substrate 3.0 Micrometers

A 3.0 micrometer layer of 3M PFSA 825EW was coated and ion exchanged as described in Example 32. The sample was tested in Method 1 for selectivity and flux (Table 7).

### Example 37; 825 EW Ionomer on Nanoporous Substrate 4.5 Micrometers

A 4.5 micrometer layer of 3M PFSA 825EW was coated and ion exchanged as described in Example 32. The sample was tested in Method 1 for selectivity and flux (Table 7).

TABLE 7

| | | Ionomer | | | Selec- | Ethanol |
|---|---|---|---|---|---|---|
| | | thickness | Counter | | tivity | Flux |
| Example | Ionomer | (μm) | Ion | Support | (%) | (Kg/m²/hr) |
| 32 | 825 EW | 0.5 | Li⁺ | PA350 | 86.70% | 3.72 |
| 33 | 825 EW | 1 | Li⁺ | PA350 | 80.60% | 3.8 |
| 34 | 825 EW | 1.5 | Li⁺ | PA350 | 84.30% | 3.61 |
| 35 | 825 EW | 2 | Li⁺ | PA350 | 86.80% | 3.47 |
| 36 | 825 EW | 3 | Li⁺ | PA350 | 90.00% | 3.08 |
| 37 | 825 EW | 4.5 | Li⁺ | PA350 | 92.60% | 2.51 |

### Example 38; 825 EW Ionomer on Nanoporous Substrate H⁺ Form

A 3 micrometer layer of 3M PFSA 825 EW ionomer was coated onto a PE2 (polyether sulfone) nanoporous substrate by casting a 10 weight percent solids dispersion in ethanol (75 weight percent) and water (25 weight percent) using a Hirano coating line using a slot die. The solvent was evaporated in four temperature controlled ovens set to 40° C., 40° C., 60° C., and 70° C. with the line moving at 2 meters per minute. The sample was tested in Method 1 for selectivity and flux (Table 8).

### Example 39; 825 EW Ionomer on Nanoporous Substrate Li⁺ Form

The membrane described in Example 38 was ion exchanged by soaking in 1M LiCl for 30 minutes followed by rinsing in deionized water and then allowed to try at room temperature overnight. The sample was tested in Method 1 for selectivity and flux (Table 8).

TABLE 8

| | | Ionomer | | | Selec- | Ethanol |
|---|---|---|---|---|---|---|
| | | thickness | Counter | | tivity | Flux |
| Example | Ionomer | (μm) | Ion | Support | (%) | (Kg/m²/hr) |
| 38 | 825 EW | 3 | H+ | PE2 | 86.69% | 2.02 |
| 39 | 825 EW | 3 | Li+ | PE2 | 94.07% | 1.25 |

### Examples 40-46 Illustrate Membrane having a Thin Ionomer Coating with Various Ionomers Example 40

One weight percent (1 wt-%) 3M PFSA 725EW was dispersed into a solvent mixture (75 wt-% EtOH and 25 wt-% deionized water). A polyacrylonitrile nanoporous substrate PA350 was coated with the solution above using a Mayer rod #6 and the solvent was allowed to evaporate at room temperature for at least 2 hours. Isooctane was dropped onto the dried, coated membrane surface and was found to wick through instantly. The penetration of isooctane is believed to indicate that there was not enough PFSA 725 EW applied to this substrate to form a continuous selective coated membrane. No other testing was conducted with this membrane.

### Example 41

A membrane was prepared as in Example 40 except the coating solution was 1.0 wt-% 3M PFSA 1000EW. No isooctane wicking through the membrane was observed. The SEM cross-section image (in FIG. 8) shows a continuous layer (1) (about 0.18 μm thick) deposited onto porous support (2). The membrane was tested by pervaporation in Method 1 above with the results shown in Table 9.

### Example 42

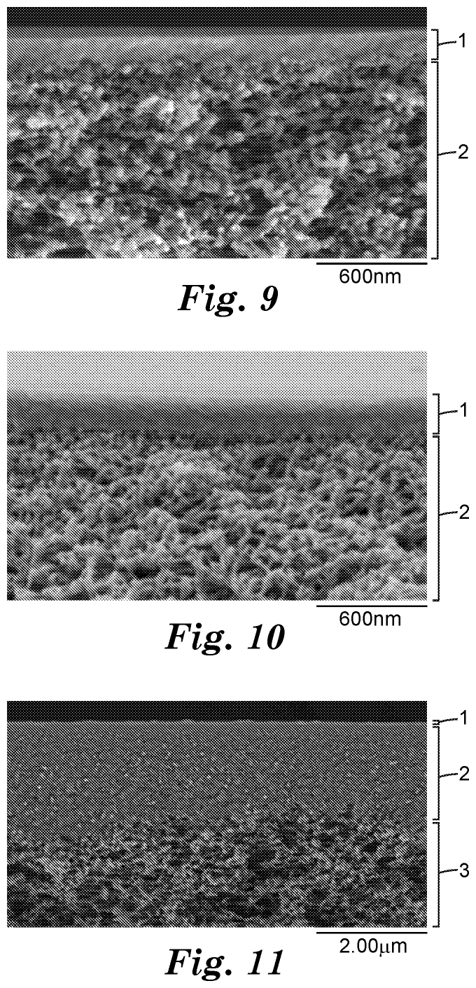

A composite membrane was prepared as in Example 40 above except the coating solution was 1.0 wt-% NAFION 2020. No isooctane wicking through the membrane was observed. The SEM cross-section image (in FIG. 9) shows a continuous layer (1) (about 0.2 μm thick) deposited onto a porous substrate (2). The membrane was tested by pervaporation in Method 1 above with the results shown in Table 9.

### Example 43

A composite membrane was prepared as in Example 42 above except PE5 was used as received for the substrate. The membrane was tested by pervaporation in Method 1 above with the results shown in Table 9.

### Example 44

A composite membrane was prepared as in Example 42 above except the coating solution was 5.0 wt-% NAFION 2020. The membrane was tested by pervaporation in Method 1 above with the results shown in Table 9.

### Example 45

A coating solution was prepared by mixing 4.0 wt-% 3M PFSA 1000EW and 96.0 wt % a solvent mixture (75 wt-% EtOH and 25 wt-% deionized water). The coating solution was applied on top of a PA350 substrate at the nanoporous side using a slot die in a pilot line. The line speed was set at 4.0 meter/min and the coating conditions targeted at 0.2 μm thickness of dry thin film coating. The coated membrane was dried by passing through an oven 7.62 meters long with the temperature 25˜40° C. in different zones. The composite membrane was tested by pervaporation in Method 1 above with the results shown in Table 9.

No isooctane wicking through the composite membrane produced in the pilot line was observed. SEM cross-section image of the membrane (FIG. 10) shows a continuous layer (1) (having a thickness close to that targeted) deposited on a porous substrate (2).

### Example 46

A composite membrane was prepared as in Example 45 above except the coating solution contained 1.0 wt-% 3M PFSA 1000EW and 99.0 wt-% a solvent mixture (75 wt-% EtOH and 25 wt-% deionized water). The line speed was set at 6.0 meters/minute (m/min) and the solution feed rate was set at 11.68 grams/minute (g/min). The coating conditions targeted a 0.05 μm dry film thickness. The dried composite membrane was tested by pervaporation in Method 1 above with the results shown in Table 1.

### Examples 47-55 illustrates hybrid membranes prepared from ionomers and acrylates Example 47

A coating solution contained 0.83 wt-% 3M PFSA-1000EW, 15.50 wt-% SR344 (polyethyleneglycol 400 diacrylate), and photoinitiator PHOTO1173 was added at 1.10 wt-% relative to the SR344 in a solvent mixture (75 wt-% EtOH and 25 wt-% deionized water).

The mixed solution was applied to PA350 at the nanoporous side using a Mayer rod #6. After 5 minutes solvent evaporation at room temperature, the coated membrane was cured in 600 watts Fusion UV system equipped with H bulb and aluminum reflector under a nitrogen purge. The line speed was set at 6.1 m/min. The membrane was tested by pervaporation with gasoline as in Method 1 with the results shown in Table 9.

### Example 48

A hybrid composite membrane was prepared as in Example 47 except that the UV curing speed was set at 18.2 m/min. The membrane was tested by pervaporation with gasoline as in Method 1 with the results shown in Table 9.

In contrast to the ionomer membrane in Example #45, which coating was easily damaged by a wiping test using a water wetted clean wiper, both hybrid composite membranes in Example 47 and 48 survived the wiping test.

### Example 49

A hybrid composite membrane was prepared as in Example 47 except that the coating solution contained 1.0 wt-% 3M PFSA-1000EW, 5.0 wt-% SR344, and 0.03 wt-% PHOTO1173 relative to SR344, and the UV curing speed was set at 18.2 m/min. The membrane was tested by pervaporation with gasoline as in Method 1 with the results shown in Table 9.

### Example 50

A hybrid composite membrane was prepared as in Example 47 except that the coating solution contained 1.0 wt-% 3M PFSA-1000EW, 10.3 wt-% SR344, and 0.04 wt-% PHOTO1173 relative to SR344, and the UV curing speed was set at 18.2 m/min. The membrane was tested by pervaporation with gasoline as in Method 1 with the results shown in Table 9.

### Example 51

A hybrid composite membrane was prepared as in Example 47 except that the coating solution contained 1.0 wt-% 3M PFSA-1000EW, 19.9 wt-% SR344, and 0.05 wt-% PHOTO1173 relative to SR344, and the UV curing speed was set at 18.2 m/min. The membrane was tested by pervaporation with gasoline as in Method 1 and the results showed in Table 9. The fractured cross-section of the hybrid membrane (FIG. 11) was imaged by a SEM. Two distinct two coating layers were observed with a thicker pore-filling layer (2) about 2 μm thick, which is likely formed by the UV cured acrylate, and a thinner top layer (1) about 0.2 μm, which is likely formed both PFSA-1000EW and the UV cured acrylate, deposited on a porous substrate (3).

### Example 52

A hybrid composite membrane was prepared as in Example 47 except that the coating solution contained 1.0 wt-% 3M PFSA-1000EW, 40.0 wt-% SR344, and 0.06 wt-% PHOTO1173 relative to SR344, and the UV curing speed was set at 18.2 m/min. The membrane was tested by pervaporation with gasoline as in Method 1 with the results shown in Table 9.

### Example 53

A hybrid composite membrane was prepared as in Example 47 except that the coating solution contained 1.0 wt-% 3M PFSA-1000EW, 20.0 wt-% SR610 (polyethyleneglycol 600 diacrylate) and 0.05 wt-% PHOTO1173 relative to SR610, and the UV curing speed was set at 18.2 m/min. The membrane was tested by pervaporation with gasoline as in Method 1 with the results shown in Table 9.

### Example 54

A hybrid composite membrane was prepared as in Example 47 except that the coating solution contained 1.0 wt-% 3M PFSA-1000EW, 20.2 wt-% SR603OP (polyethylene glycol 400 dimethacrylate) and 0.05 wt-% PHOTO1173 relative to SR603OP, and the UV curing speed was set at 18.2 m/min. The membrane was tested by pervaporation with gasoline as in Method 1 with the results shown in Table 9.

### Example 55 Illustrates an Overcoating Method to Prepare a Hybrid Membrane

### Example 55

A solution was prepared by mixing 2.04 grams (g) SR610, 0.25 g polyacrylic acid (50% aqueous solution, MW 5000), 0.12 g photoinitiator PHOTO1173, and 17.66 g solvent mixture (EtOH/H2O, 75/25 mass ratio). The solution which did not contain any ionomer was applied to the top of the membrane in Example 45 using Mayer rod #6. The solvent was evaporated at room temperature before UV curing. The curing was conducted in a Fusion UV system equipped with H bulb and aluminum reflector under nitrogen inert environment and the line speed was set at 6.02meter/min. The membrane was tested by pervaporation with gasoline as in Method 1 and the results showed in Table 9. As can be seen, this hybrid membrane showed 37% higher ethanol flux than the ionomer membrane in Example 45.

### Examples 56-60 Illustrates Hybrid Membranes Prepared from Ionomers and Epoxy

### Example 56

3M PFSA Ionomer EW825 was dispersed in EtOH/H₂O (75/25 mass ratio) to prepare a 30 wt-% PFSA-825EW stock solution. JEFFAMINE D400 and epoxy EX614B (sorbitol polyglycidyl ether) were dissolved in MEK to prepare a 20 wt-% amine and epoxy stock solution, respectively.

The stock solutions above ware mixed with EtOH to get a final coating solution containing 9.0 wt-% 3M PFSA-825EW, 1.0 wt % EX614B and 0.62 wt-% JEFFAMINE D400. The coating solution was applied to the nanoporous side of PA350 using a Mayer rod with the target dry coating thickness of 4 μm. The coated membrane was dried and heat treated in a convection oven at 80° C. for 1 hour before evaluation in Method 4. The testing results are shown in Table 9.

### Example 57

A membrane was prepared as in Example 56 except that the coating solution contained 4.0wt-% 3M PFSA-825EW and the target dry coating thickness was 5 μm. The testing results are shown in Table 9.

### Example 58

A membrane was prepared as in Example 56 except that the coating solution contained 2.33 wt-% 3M PFSA-825EW, 1.00 wt-% EX512 (polyglycerol polyglycidyl ether) and 0.62 wt-% JEFFAMINE D400. The target dry coating thickness was 5 μm. The testing results are shown in Table 9.

### Example 59

A membrane was prepared as in Example 56 except that the coating solution contained 9.00 wt-% 3M PFSA-825EW, 1.00 wt-% EX521 (polyglycerol polyglycidyl ether) and 0.59 wt-% JEFFAMINE D400. The target dry coating thickness was 4 μm. The testing results are shown in Table 9.

### Example 60

A membrane was prepared as in Example 56 except that the coating solution contained only 9.0 wt-% 3M PFSA-825EW and had no epoxy/amine component. The target dry coating thickness was 2 μm. The testing results are shown in Table 9.

Cracking resistance of Examples 56-60 was evaluated by folding the coating side facing inside and observing if any crack formed along the folding line. A severe crack was observed with the membrane in Example 60, no crack was observed for membranes in Examples 57 and 58, and a small crack was for membranes in Examples 56 and 59.

### Examples 61-71 Illustrate Membranes Prepared from PFSA//RTIL (Room Temperature Ionic Liquid)

### Example 61

A coating solution was prepared by mixing 1.25 wt-% 3M PFSA-1000EW, 1.25 wt-% EMIM-Tf₂N (1-ethyl-3-methylimidazolium bis(trifluoromethylsulfonyl)imide RTIL) in a solvent mixture (75 wt-% EtOH and 25 wt-% deionized water). The coating solution was applied to PA350 at the nanoporous side using a Mayer rod #6 and the solvent was allowed to evaporate at room temperature for at least 2 hours and then further dried at 80° C. under 8.0 kPa vacuum. The membrane was tested by pervaporation in Method 1 above with the results shown in Table 9.

### Example 62

A membrane was prepared as in Example 61 except that the coating solution contained 2.5 wt-% 3M PFSA-1000EW only without any RTIL additive. The membrane was tested by pervaporation in Method 1 above with the results shown in Table 9.

### Example 63

A membrane was prepared as in Example 61 except that the coating solution contained 2.5 wt-%3M PFSA-1000EW and 2.5 wt-% EMIM-Tf₂N. The membrane was tested by pervaporation in Method 1 above with the results shown in Table 9.

### Example 64

A membrane was prepared as in Example 61 except the coating solution was prepared by mixing 1.25 wt-% 3M PFSA-EW725, 1.25 wt-% EMIM-Tf₂N, and the solvent mixture (ethanol/water, 75/25 mass ratio). The membrane was tested by pervaporation in Method 1 above with the results shown in Table 9.

### Example 65

A membrane was prepared as in Example 61 except the coating solution was prepared by mixing 1.25 wt-% NAFION 2020, 0.50 wt-% 1-ethyl-3-methylimidazolium tetrafluoroborate (EMIM-BF4), in a solvent mixture of 75 wt-% ethanol 25 wt-%. The molar ratio of EMIM-BF4 to NAFION 2020 sulfonic acid was 2.0. The membrane was tested by pervaporation in Method 1 above with the results shown in Table 9.

### Example 66

A membrane was prepared as Example 61 except the coating solution was prepared by mixing 1.25 wt-% NAFION 2020, 0.50 wt-% 1-ethyl-3-methylimidazolium trifluoromethanesulfonate (EMIM-TFSA), in a solvent mixture of 75 wt-% ethanol and 25 wt-% water. The molar ratio of EMIM-TFSA to NAFION 2020 sulfonic acid was 2.0. The membrane was tested by pervaporation in Method 1 above with the results shown in Table 9.

### Example 67

A membrane was prepared as Example 61 except the coating solution was prepared by mixing 1.25 wt-% NAFION 2020, 0.71 wt-% 1-Hexyl-3-methylimidazolium tetracyanoborate (HMIM-B(CN)4), and the solvent mixture of 75 wt-% ethanol and 25 wt-% water. The molar ratio of EMIM-TFSA to NAFION 2020 sulfonic acid was 2.0. The membrane was tested by pervaporation in Method 1 above with the results shown in Table 9.

### Example 68

A membrane was prepared as in Example 61 except that the coating solution was prepared by mixing 1.5 wt-% 3M PFSA-825EW, 3.5 wt-% EMIM-Tf₂N and a solvent mixture of of 75 wt-% ethanol and 25 wt-% water. The total solid content in the coating solution was 5 wt-% and the molar ratio of RTIL to PFSA-825EW functionality was 4.92. The membranes were tested by pervaporation in Method 1 and Method 2 with the results shown in the Table 9 and 10, respectively.

### Example 69

A membrane was prepared as in Example 61 except that the coating solution was prepared by mixing 2.0 wt-% 3M PFSA-825EW, 3.0 wt-% EMIM-Tf₂N and a solvent mixture of 75 wt-% ethanol and 25 wt-% water. The total solid content in the coating solution remained 5 wt-% and the molar ratio of RTIL to PFSA-825EW functionality was 3.16. The membranes were tested by pervaporation in Method 1 and Method 2 with the results shown in the Table 9 and 10, respectively.

### Example 70

A membrane was prepared as in Example 61 except that the coating solution was prepared by mixing 2.5 wt-% 3M PFSA-825EW, 2.5 wt-% EMIM-Tf₂N and a solvent mixture of 75 wt-% ethanol and 25 wt-% water. The total solid content in the coating solution remained 5 wt-% and the molar ratio of RTIL to PFSA-825EW functionality was 2.11. The membrane was tested by pervaporation in Method 2 with the results shown in the Table 10.

### Example 71

A membrane was prepared as in Example 61 except that the coating solution was prepared by mixing 3.5 wt-% 3M PFSA-825EW, 1.5 wt-% EMIM-Tf₂N and a solvent mixture of 75 wt-% ethanol and 25 wt-% water. The total solid content in the coating solution remained 5 wt-% and the molar ratio of RTIL to PFSA-825EW functionality was 0.90. The membrane was tested by pervaporation in Method 2 with the results shown in the Table 10.

### Example 72

A coating solution was prepared by mixing 6.00 wt-% 3M PFSA-1000EW, 3.12 wt-% EMIM-TFSA, and a solvent mixture of 60 wt-% ethanol and 40 wt-% deionized water. The solution had EMIM-TFSA/PFSA-1000EW molar ratio of 2.0. The coating solution was applied to a PA350 substrate using a slot die in a pilot line. The line speed was set at 6.0 meter/min and this coating conditions targeted at 0.2 μm thickness of dry thin film coating. The coated membrane was dried by passing through a 7.6 meter long oven with the temperature 25˜40° C. in different zones. The dried composite membrane was tested by pervaporation in Method 1 and Method 2 with the results shown in the Table 9 and 10, respectively.

### Example 73

A membrane was prepared as in Example 72 except that the coating solution was made by mixing 1.00 wt-% PFSA-1000EW, 0.52 wt-% EMIM-TFSA, and a solvent mixture of 60 wt-% ethanol and 40 wt-% deionized water. Target thickness was 0.1 μm. The dried composite membrane was tested by pervaporation in Method 1 with the results shown in the Table 9.

### Examples 74-77 illustrates a PFSA membrane with a 2^{nd} amorphous perfluoropolymer top coating layer

### Example 74

The membrane in Example 73 was coated with 0.5 wt-% TEFLON AF2400 in 3M Novec solvent HFE7200 using a Mayer rod #5. The dry AF2400 second layer coating thickness target was 0.034 μm. The solvent was evaporated at ambient conditions for at least two hours. The dual layer coated membrane was tested by pervaporation in Method 1 above with the results shown in Table 9.

Both membranes in Examples 73 and 74 were tested four times as in Method 1 to evaluate membrane performance stability with the results shown in Table 13. The membrane without a 2^{11d} layer coating showed a steep decline in ethanol selectivity over repeating testing (i.e., sequentially repeated testing of the membrane for Test 1 to Test 4), while AF2400 coated membrane in Example 74 gave consistent ethanol selectivity in this performance durability testing.

A spiral-wound module was prepared from the membrane of Example 74 using the following procedure and materials. Polyphenlyene sulfide extruded mesh available under the product number N01328_60PPS-NAT (or PPS P861) (from Delstar Technologies Inc., Middleton, Del.) was used as the feed spacer. One sheet of polyester woven mesh available under the trade name WS0300 (from Industrial Netting, Minneapolis, Minn.) and one sheet of polybutylene terephthalate asymmetrical extruded mesh available under the product number N02413/19_45PBTNAT (or PBT P864) (from Delstar Technologies Inc., Middleton, Del.) were stacked over each other and used as the permeate spacer. Seven membrane sheets (Example 74) (540 mm long) were pre-cut (25.4 cm width) and folded nonwoven side out about 255 mm from one end so that one end over hung the other by about 15 mm. Each membrane folder was inserted with the feed spacer. Pore sealant was mixed from difunctional bisphenol A epoxy resin available under the trade name EPON 828 (from Momentive Company, Columbus), triethylenetetraamine (Alfa Aesar, Heysham, England), and epoxy adhesive available under the trade name SCOTCH-WELD-DP760 (from 3M France, Bd de Poise, Cergy Pontoise Cedex, France) at a 21:3:8 weight ratio. The pore sealant was applied by a brush to the nonwoven side of the membrane to a width of 20 mm on the overhanging end and 30 mm wide to the edges. The membrane folders with the feed spacers were then stacked with the folded edge toward the permeate collection tube and the permeate spacer slightly overhanging toward the permeate collection tube. DP760 epoxy adhesive was applied to seal the permeate spacers between each membrane folders such that the permeate spacers remained open to the permeate collection tube. The stack of membrane folders and permeate spacers were wound around a stainless steel permeate collection tube (dimensions of 13 mm outside diameter and 51cm in length) to form a module. The collection tube had approximately 50-75% open area/perforations (15.24 cm in length). The module was then cured at 80° C. for 2 hours in an oven. The module was then trimmed at two ends to expose the feed spacers before commencing the integrity testing. The module showed the vacuum integrity (<1.3 kPa), which indicates it was well sealed. The module had an active membrane area 0.70 m² and a total volume 0.76 liter. It was housed in a stainless steel canister for performance evaluation under conditions (fuel temperature 70° C. and flow rate of 2 liter/min, and 2.67 kPa vacuum pressure on the permeate), the module gave an average ethanol flux 0.82 kg/hr and 67.2% average permeate ethanol selectivity

### Example 75

A dual layer coated membrane was prepared as in Example 74 except the membrane in Example 45 was coated with AF2400. The membrane was tested by pervaporation in Method 1 above with the results shown in Table 9.

### Example 76

A dual layer coated membrane was prepared as in Example 74 except a 0.1 wt-% AF2400 solution was used for the second layer coating and its coating thickness was 0.011 μm. The membrane was tested by pervaporation in Method 1 above with the results shown in Table 9.

### Example 77

A dual layer coated membrane was prepared as in Example 74 except a 0.5 wt-% AF2400 solution was used for the second layer coating and its target coating thickness was 0.057 μm. The membrane was tested by pervaporation in Method 1 above with the results shown in Table 9.

TABLE 9

| | Total Permeate | Feed EtOH | Permeate EtOH (wt- | EtOH Flux |
|---|---|---|---|---|
| Example | Flux (kg/m² · h) | (wt-%) | %) | (kg/m² · h) |
| 41 | 4.00 | 8.6% | 76.6% | 3.06 |
| 42 | 4.71 | 8.9% | 71.0% | 3.35 |
| 43 | 0.96 | 9.3% | 87.9% | 0.85 |
| 44 | 3.43 | 8.8% | 77.3% | 2.64 |
| 45 | 2.71 | 8.3% | 95.4% | 2.59 |
| 46 | 6.00 | 8.9% | 60.5% | 3.63 |
| 47 | 4.86 | 8.7% | 70.0% | 3.40 |
| 48 | 5.00 | 9.2% | 70.0% | 3.50 |
| 49 | 5.29 | 8.7% | 71.4% | 3.77 |
| 50 | 5.29 | 8.7% | 68.3% | 3.61 |
| 51 | 5.71 | 8.6% | 63.4% | 3.62 |
| 52 | 4.00 | 9.0% | 69.1% | 2.76 |
| 53 | 6.29 | 8.8% | 60.1% | 3.78 |
| 54 | 7.00 | 8.7% | 61.4% | 4.30 |
| 55 | 5.14 | 8.8% | 68.9% | 3.55 |
| 56 | — | — | 82.3% | 1.85 |
| 57 | — | — | 79.3% | 1.13 |
| 58 | — | — | 84.9% | 0.93 |
| 59 | — | — | 77.9% | 1.76 |
| 60 | — | — | 67.0% | 1.99 |
| 61 | 5.00 | 8.8% | 68.7% | 3.43 |
| 62 | 3.57 | 8.4% | 81.8% | 2.92 |
| 63 | 4.43 | 8.7% | 76.1% | 3.37 |
| 64 | 4.14 | 8.6% | 78.3% | 3.24 |
| 65 | 5.57 | 8.4% | 67.4% | 3.76 |
| 66 | 4.86 | 8.8% | 70.4% | 3.42 |
| 67 | 5.76 | 8.8% | 61.5% | 3.54 |
| 68 | 5.86 | 7.7% | 64.4% | 3.77 |
| 69 | 5.14 | 8.5% | 68.7% | 3.53 |
| 70 | — | — | — | — |
| 71 | — | — | — | — |
| 72 | 4.71 | 8.0% | 80.5% | 3.79 |
| 73 | 5.00 | 8.9% | 71.1% | 3.55 |
| 74 | 6.00 | 8.6% | 67.3% | 4.03 |
| 75 | 4.57 | 8.9% | 77.8% | 3.55 |
| 76 | 5.14 | 9.0% | 68.0% | 3.50 |
| 77 | 6.00 | 8.6% | 64.5% | 3.86 |

TABLE 10

| | Permeate EtOH | |
|---|---|---|
| Example | (wt-%) | EtOH Flux (kg/m² · h) |
| 68 | 51.6% | 1.95 |
| 69 | 49.3% | 1.64 |
| 70 | 75.0% | 1.61 |
| 71 | 80.2% | 1.54 |
| 72 | 82.9% | 1.72 |

### Example 78

A membrane roll was prepared as in Example 73 except that the temperatures were 40° C., 50° C., 60° C., and 70° C. in a four zoned oven. The membrane roll was plasma treated according to US2003/0134515 with C₆F₁₄, C₆F₁₄/O₂ and C₃F₈ as a fluorine gas source. The amorphous fluorocarbon film was only deposited at the PFSA coated side of the membrane. The process conditions was shown in Table 11 and the membranes were tested by pervaporation in Method 1 with the results shown in Table 12.

The plasma fluorocarbon film coating form C₆F₁₄ did not change the performance. The film from C₆F₁₄/O₂ and C₃F₈ did decrease ethanol selectivity to various degrees. Under plasma deposition conditions such as 1000 watts and 0.76 meter/min using C₆F₁₄/O₂ or C₃F₈ as source gases, the PFSA coating layer of the base membrane was likely etched out which caused excessive total permeate flux and no ethanol selectivity.

The membrane in Example 78-17 was evaluated with four consecutive tests in Method 1 to evaluate membrane performance stability with the results shown in Table 13. Similar to Example 74, the plasma fluorocarbon film deposited membrane did not show a decline in ethanol selectivity.

Some plasma fluorocarbon film deposited membranes were also evaluated in Method 5 for long term performance stability with the results shown in Table 14. Most of membranes had significant ethanol selectivity change after their 140 hours hot gasoline exposure. However the membrane in Example 78-2 gave less than 15% change in permeate ethanol, the most stable performance.

TABLE 11

| | | | Gas 1 | Gas 2 | Power | Line Speed | Pressure |
|---|---|---|---|---|---|---|---|
| Example | Gas 1 | Gas 2 | sccm | sccm | (watts) | (meter/min) | (Pa) |
| 78-1 | — | — | — | — | — | — | — |
| 78-2 | C₆F₁₄ | — | 600 | — | 1000 | 0.76 | 0.55 |
| 78-3 | C₆F₁₄ | — | 600 | — | 500 | 0.76 | 0.55 |
| 78-4 | C₆F₁₄ | — | 600 | — | 200 | 0.76 | 0.55 |
| 78-5 | C₆F₁₄ | — | 600 | — | 1000 | 3.05 | 0.93 |
| 78-6 | C₆F₁₄ | — | 600 | — | 500 | 3.05 | 0.93 |
| 78-7 | C₆F₁₄ | — | 600 | — | 200 | 3.05 | 0.93 |
| 78-8 | C₆F₁₄ | — | 600 | — | 1000 | 9.14 | 1.67 |
| 78-9 | C₆F₁₄ | — | 600 | — | 500 | 9.14 | 1.67 |
| 78-10 | C₆F₁₄ | — | 600 | — | 200 | 9.14 | 1.67 |
| 78-11 | C₆F₁₄ | O₂ | 600 | 300 | 1000 | 0.76 | 0.64 |
| 78-12 | C₆F₁₄ | O₂ | 600 | 300 | 500 | 0.76 | 0.64 |
| 78-13 | C₆F₁₄ | O₂ | 600 | 300 | 200 | 0.76 | 0.64 |
| 78-14 | C₆F₁₄ | O₂ | 600 | 300 | 1000 | 3.05 | 0.99 |
| 78-15 | C₆F₁₄ | O₂ | 600 | 300 | 500 | 3.05 | 0.99 |
| 78-16 | C₆F₁₄ | O₂ | 600 | 300 | 200 | 3.05 | 0.99 |
| 78-17 | C₆F₁₄ | O₂ | 600 | 300 | 1000 | 9.14 | 1.60 |
| 78-18 | C₆F₁₄ | O₂ | 600 | 300 | 500 | 9.14 | 1.60 |
| 78-19 | C₆F₁₄ | O₂ | 600 | 300 | 200 | 9.14 | 1.60 |
| 78-20 | C₃F₈ | — | 600 | — | 1000 | 0.76 | 0.84 |
| 78-21 | C₃F₈ | — | 600 | — | 500 | 0.76 | 0.84 |
| 78-22 | C₃F₈ | — | 600 | — | 200 | 0.76 | 0.84 |
| 78-23 | C₃F₈ | — | 600 | — | 1000 | 3.05 | 1.13 |
| 78-24 | C₃F₈ | — | 600 | — | 500 | 3.05 | 1.13 |
| 78-25 | C₃F₈ | — | 600 | — | 200 | 3.05 | 1.13 |
| 78-26 | C₃F₈ | — | 600 | — | 1000 | 9.14 | 1.84 |
| 78-27 | C₃F₈ | — | 600 | — | 500 | 9.14 | 1.84 |
| 78-28 | C₃F₈ | — | 600 | — | 200 | 9.14 | 1.84 |

TABLE 12

| | Total Permeate | Feed EtOH | Permeate | EtOH Flux |
|---|---|---|---|---|
| Example | Flux (kg/m² · h) | (wt-%) | EtOH (wt-%) | (kg/m² · h) |
| 78-1 | 5.00 | 8.2% | 82.8% | 4.13 |
| 78-2 | 5.29 | 8.7% | 82.3% | 4.35 |
| 78-3 | 4.57 | 7.8% | 86.4% | 3.95 |
| 78-4 | 5.00 | 8.4% | 83.5% | 4.17 |
| 78-5 | 4.86 | 9.0% | 86.3% | 4.19 |
| 78-6 | 4.86 | 8.5% | 84.0% | 4.08 |
| 78-7 | 5.43 | 8.4% | 81.5% | 4.42 |
| 78-8 | 5.36 | 8.5% | 82.3% | 4.41 |
| 78-9 | 5.43 | 8.9% | 80.4% | 4.36 |
| 78-10 | 5.71 | 8.1% | 80.1% | 4.58 |
| 78-11 | >100 | — | — | — |
| 78-12 | 5.71 | 8.4% | 72.8% | 4.16 |
| 78-13 | 5.86 | 8.7% | 77.5% | 4.54 |
| 78-14 | 5.57 | 8.5% | 81.6% | 4.54 |
| 78-15 | 5.71 | 8.5% | 79.0% | 4.51 |
| 78-16 | 5.86 | 8.7% | 77.3% | 4.53 |
| 78-17 | 5.86 | 8.4% | 80.1% | 4.69 |
| 78-18 | 5.86 | 8.7% | 77.3% | 4.53 |
| 78-19 | 6.00 | 8.1% | 80.0% | 4.79 |
| 78-20 | >100 | — | — | — |
| 78-21 | 6.00 | 8.5% | 75.0% | 4.50 |
| 78-22 | 2.57 | 3.5% | 74.8% | 1.93 |
| 78-23 | 6.29 | 7.9% | 73.4% | 4.61 |
| 78-24 | 5.86 | 8.6% | 75.1% | 4.40 |
| 78-25 | 6.29 | 8.5% | 73.6% | 4.62 |
| 78-26 | 5.57 | 8.5% | 76.2% | 4.24 |
| 78-27 | 5.86 | 8.3% | 78.9% | 4.62 |
| 78-28 | 5.71 | 8.5% | 76.2% | 4.36 |

TABLE 13

| | | | Feed | Permeate | |
|---|---|---|---|---|---|
| | Durability | Total Permeate | EtOH | EtOH | EtOH Flux |
| Example | test | Flux (kg/m² · h) | (wt-%) | (wt-%) | (kg/m² · h) |
| 73 | Test 1 | 5.00 | 8.9% | 71.1% | 3.55 |
| | Test 2 | 6.00 | 9.1% | 59.8% | 3.59 |
| | Test 3 | 7.43 | 9.2% | 47.5% | 3.53 |
| | Test 4 | 12.00 | 9.4% | 31.8% | 3.82 |
| 74 | Test 1 | 5.57 | 8.8% | 65.0% | 3.61 |
| | Test 2 | 5.43 | 8.7% | 65.8% | 3.57 |
| | Test 3 | 5.57 | 9.0% | 63.0% | 3.51 |
| | Test 4 | 5.71 | 8.8% | 61.4% | 3.51 |
| 78-17 | Test 1 | 5.57 | 8.4% | 80.6% | 4.49 |
| | Test 2 | 5.43 | 8.5% | 82.3% | 4.47 |
| | Test 3 | 5.29 | 8.5% | 81.9% | 4.33 |
| | Test 4 | 5.29 | 8.7% | 82.5% | 4.36 |

TABLE 14

| | | Total | | | |
|---|---|---|---|---|---|
| | 140 hrs hot | Permeate | | Permeate | |
| | gasoline | Flux | Feed EtOH | EtOH (wt- | EtOH Flux |
| Example | exposure | (kg/m² · h) | (wt-%) | %) | (kg/m² · h) |
| 78-2 | Before | 5.29 | 8.7% | 82.3% | 4.35 |
| | After | 5.71 | 8.9% | 72.7% | 4.15 |
| 78-3 | Before | 4.57 | 7.8% | 86.4% | 3.95 |
| | After | 6.71 | 8.5% | 64.3% | 4.31 |
| 78-4 | Before | 5.00 | 8.4% | 83.5% | 4.17 |
| | After | 7.43 | 8.7% | 43.5% | 3.18 |
| 78-8 | Before | 5.36 | 8.5% | 82.3% | 4.39 |
| | After | 8.43 | — | 53.8% | 4.53 |
| 78-17 | Before | 6.29 | 8.4% | 78.6% | 4.94 |
| | After | 10.43 | 8.5% | 46.6% | 4.85 |
| 78-25 | Before | 6.29 | 8.5% | 73.6% | 4.62 |
| | After | 9.71 | — | 52.6% | 5.11 |

### Example 79

A first coating solution was prepared by mixing 5.0 wt-% 3M PFSA 1000EW and 95.0 wt-% a solvent mixture (67.0 wt-% EtOH and 33.0 wt-% deionized water). The coating solution was applied on top of a PA350 substrate at the nanoporous side using a slot die in a pilot line. The line speed was set at 6.0 meter/min and the coating conditions targeted at 0.2 μm thickness of dry thin film coating. The coated membrane was dried by passing through an oven 7.62 meters long with the temperature 25° C. to 40° C. in different zones.

A second solution was prepared by mixing 10.0 wt-% SR344 and 90.0 wt-% a solvent mixture (75.0 wt-% EtOH and 25.0 wt-% deionized water). This second solution was applied to the membrane above at the PFSA coated side using a slot die in the same pilot line under the same conditions as above except that the dry thin film coating was targeted at 0.5 μm thickness.

The membrane prepared above was cured in 600 watts Fusion UV system equipped with H bulb and aluminum reflector under a nitrogen purge. The line speed was set at 6.1 m/min. the cured composite membrane was tested by pervaporation in Method 6 above with the results shown in Table 15. As can be seen, the membrane showed enrichment effect of aromatics from 33.3% (excluding EtOH in the feed) to 37.9% (excluding EtOH in the permeate).

TABLE 15

| | Total | | Permeate | Permeate | Total fluxes |
|---|---|---|---|---|---|
| | Mass | | aromatics | overall | (EtOH + |
| | Flux | Permeate | excluding | (EtOH + | aromatics) |
| Example | (kg/m²/h) | EtOH Conc. | EtOH | aromatics) | (kg/m²/h) |
| 79 | 2.43 | 70.3% | 37.9% | 81.6% | 1.98 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A method of selectively pervaporating a first liquid from a feed mixture comprising the first liquid and a second liquid, the method comprising contacting the feed mixture with a separation membrane comprising a polymeric ionomer, wherein the polymeric ionomer has a highly fluorinated backbone and recurring pendant groups according to the following formula (Formula I):
—O—R_{f}—[—SO₂—N⁻(Z⁺)—SO₂—R—]ₘ—[SO₂]ₙ-Q
wherein:
R_{f} is a perfluorinated organic linking group;
R is an organic linking group;
Z⁺ is H⁺, a monovalent cation, or a multivalent cation;
Q is H, F, —NH₂, —O⁻Y⁺, or —CₓF₂ₓ₊₁;
Y⁺ is H⁺, a monovalent cation, or a multivalent cation;
x=1 to 4;
m=0 to 6; and
n=0 or 1;
with the proviso that at least one of m or n must be non-zero;
wherein the polymeric ionomer is more permeable to the first liquid than the second liquid;
with the proviso that when m=0 and Q is —O⁻Y⁺, the first liquid is a high octane compound and the second liquid is gasoline.

2. A separation membrane for selectively pervaporating a first liquid from a feed mixture comprising the first liquid and a second liquid, the separation membrane comprising:
a polymeric ionomer in the form of a layer having a thickness, with the polymeric ionomer having a highly fluorinated backbone and recurring pendant groups according to the following formula (Formula I):
—O—R_{f}—[—SO₂—N⁻(Z⁺)—SO₂—R—]ₘ—[SO₂]ₙ-Q
wherein:
R_{f} is a perfluorinated organic linking group;
R is an organic linking group;
Z⁺ is H⁺, a monovalent cation, or a multivalent cation;
Q is H, F, —NH₂, —O⁻Y⁺, or —CₓF₂ₓ₊₁;
Y⁺ is H⁺, a monovalent cation, or a multivalent cation;
x=1 to 4;
m=0 to 6; and
n=0 or 1;
with the proviso that at least one of m or n must be non-zero;
wherein the polymeric ionomer is more permeable to the first liquid than the second liquid, Q is not —O⁻Y⁺ when m=0, and m is not 0 when Q is —O⁻Y⁺.

3. A combination of a gasoline fuel system and a separation membrane for selectively pervaporating a first liquid from a feed mixture comprising the first liquid and a second liquid, with the first liquid being a high octane compound, the second liquid being gasoline, and the separation membrane comprising:
a polymeric ionomer in the form of a layer having a thickness,
wherein the polymeric ionomer is more permeable to the high octane compound than the gasoline and has a highly fluorinated backbone and recurring pendant groups according to the following formula (Formula I):
—O—R_{f}—[—SO₂—N⁻(Z⁺)—SO₂—R—]ₘ—[SO₂]ₙ-Q
wherein:
R_{f} is a perfluorinated organic linking group;
R is an organic linking group;
Z⁺ is H⁺, a monovalent cation, or a multivalent cation;
Q is H, F, —NH₂, —O⁻Y⁺, or —CₓF₂ₓ₊₁;
Y⁺ is H⁺, a monovalent cation, or a multivalent cation;
x=1 to 4;
m=0 to 6; and
n=0 or 1;
with the proviso that at least one of m or n must be non-zero.

4. The separation module according to claim 2, wherein the separation membrane is in a cartridge.

5. The separation membrane according to claim 2, wherein the separation membrane further comprises a substrate on which the layer of the polymeric ionomer is disposed.

6. The separation membrane according to claim 5 wherein the substrate is a porous substrate comprising opposite first and second major surfaces, and a plurality of pores, and the layer of the polymeric ionomer is on a major surface of the porous substrate and optionally in the pores.

7. The separation membrane according to claim 6 wherein the porous substrate comprises a nanoporous layer, a microporous layer, and a macroporous layer in that order.

8. The separation membrane according to claim 7 wherein the substrate has a thickness measured from one to the other of the opposite major surfaces in the range of from 5 μm up to and including 500 μm.

9. The separation membrane according to claim 8 wherein the substrate comprises pores having an average size in the range of from 0.5 nanometers (nm) up to and including 1000 μm.

10. The separation membrane according to claim 9 wherein the separation membrane further comprises a (meth)acryl-containing polymer.

11. The separation membrane according to claim 10 wherein the (meth)acryl-containing polymer is at least one of mixed with the polymeric ionomer in the layer or the (meth)acryl containing polymer and polymeric ionomer are in separate layers.

12. The separation membrane according to claim 11 wherein the separation membrane further comprises an epoxy polymer.

13. The separation membrane according to claim 12 wherein the epoxy polymer is at least one of mixed with the polymeric ionomer in the layer or the epoxy polymer and polymeric ionomer are in separate layers.

14. The separation membrane according to claim 13 wherein the separation membrane further comprises at least one of:
(a) an ionic liquid mixed with the polymeric ionomer in the layer; or
(b) an amorphous fluorochemical film disposed on the separation membrane.
